(19) United States
(12) Patent Application Publication
(10) Pub. No.: US 2026/0032422 A1
(43) Pub. Date: Jan. 29, 2026

(54) LOW POWER WAKE-UP SIGNAL MONITORING WITH MULTIPLE USER SUBSCRIBER IDENTITY MODULE GAPS

(71) Applicant: QUALCOMM Incorporated, San Diego, CA (US)

(72) Inventors: Huilin XU, Temecula, CA (US); Prashant SHARMA, San Marcos, CA (US); Diana MAAMARI, San Diego, CA (US); Changhwan PARK, San Diego, CA (US)

(21) Appl. No.: 18/787,301

(22) Filed: Jul. 29, 2024

(51) Int. Cl. H04W 8/18; H04W 52/02; H04W 72/232

(52) U.S. Cl. CPC H04W 8/186; H04W 52/0229; H04W 72/232

(57) ABSTRACT

Various aspects of the present disclosure generally relate to wireless communication. In some aspects, a user equipment (UE) may receive configuration information associated with a first subscriber identity module (SIM) of the UE, wherein the configuration information is associated with configuring at least one of a set of low power wake-up signal (LP-WUS) monitoring occasions or a set of multiple user SIM (MUSIM) gaps at the UE. The UE may skip, in connection with an LP-WUS monitoring occasion at least partially overlapping with a MUSIM gap LP-WUS monitoring during the LP-WUS monitoring occasion or monitoring for a communication associated with a second SIM of the UE during the MUSIM gap based at least in part on a priority associated with the LP-WUS monitoring occasion and a priority associated with the MUSIM gap. Numerous other aspects are described.

### FIELD OF THE DISCLOSURE

Aspects of the present disclosure generally relate to wireless communication and specifically relate to techniques, apparatuses, and methods for low power wake-up signal monitoring with multiple user subscriber identity module gaps.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving configuration information associated with a first subscriber identity module (SIM) of the UE, wherein the configuration information is associated with configuring at least one of a set of low power wake-up signal (LP-WUS) monitoring occasions or a set of multiple user SIM (MUSIM) gaps at the UE. The method may include skipping, in connection with an LP-WUS monitoring occasion, of the set of LP-WUS monitoring occasions, at least partially overlapping with a MUSIM gap, of the set of MUSIM gaps, LP-WUS monitoring during the LP-WUS monitoring occasion or monitoring for a communication associated with a second SIM of the UE during the MUSIM gap based at least in part on a priority associated with the LP-WUS monitoring occasion and a priority associated with the MUSIM gap.

Some aspects described herein relate to a method of wireless communication performed by a network node. The method may include transmitting configuration information associated with a first SIM of a UE, wherein the configuration information is associated with configuring at least one of a set of LP-WUS monitoring occasions or a set of MUSIM gaps at the UE. The method may include selectively transmitting, in connection with an LP-WUS monitoring occasion, of the set of LP-WUS monitoring occasions, at least partially overlapping with a MUSIM gap, of the set of MUSIM gaps, an LP-WUS during the LP-WUS monitoring occasion based at least in part on a priority associated with the LP-WUS monitoring occasion and a priority associated with the MUSIM gap, wherein the LP-WUS is transmitted based at least in part on the priority associated with the LP-WUS monitoring occasion comprising a higher priority relative to the priority associated with the MUSIM gap.

Some aspects described herein relate to a non-transitory computer-readable medium that stores a set of instructions for wireless communication by an UE. The set of instructions, when executed by one or more processors of the UE, may cause the UE to receive configuration information associated with a first SIM of the UE, wherein the configuration information is associated with configuring at least one of a set of LP-WUS monitoring occasions or a set MUSIM gaps at the UE. The set of instructions, when executed by one or more processors of the UE, may cause the UE to skip, in connection with an LP-WUS monitoring occasion, of the set of LP-WUS monitoring occasions, at least partially overlapping with a MUSIM gap, of the set of MUSIM gaps, LP-WUS monitoring during the LP-WUS monitoring occasion or monitoring for a communication associated with a second SIM of the UE during the MUSIM gap based at least in part on a priority associated with the LP-WUS monitoring occasion and a priority associated with the MUSIM gap.

Some aspects described herein relate to a non-transitory computer-readable medium that stores a set of instructions for wireless communication by a network node. The set of instructions, when executed by one or more processors of the network node, may cause the network node to transmit configuration information associated with a first SIM of a UE, wherein the configuration information is associated with configuring at least one of a set of LP-WUS monitoring occasions or a set of MUSIM gaps at the UE. The set of instructions, when executed by one or more processors of the network node, may cause the network node to selectively transmit, in connection with an LP-WUS monitoring occasion, of the set of LP-WUS monitoring occasions, at least partially overlapping with a MUSIM gap, of the set of MUSIM gaps, an LP-WUS during the LP-WUS monitoring occasion based at least in part on a priority associated with the LP-WUS monitoring occasion and a priority associated with the MUSIM gap, wherein the LP-WUS is transmitted based at least in part on the priority associated with the LP-WUS monitoring occasion comprising a higher priority relative to the priority associated with the MUSIM gap.

Some aspects described herein relate to a UE for wireless communication. The UE may include one or more memories and one or more processors coupled to the one or more memories. The one or more processors may be configured to receive configuration information associated with a first SIM of the UE, wherein the configuration information is associated with configuring at least one of a set of LP-WUS monitoring occasions or a set of MUSIM gaps at the UE. The one or more processors may be configured to skip, in connection with an LP-WUS monitoring occasion, of the set of LP-WUS monitoring occasions, at least partially overlapping with a MUSIM gap, of the set of MUSIM gaps, LP-WUS monitoring during the LP-WUS monitoring occasion or monitoring for a communication associated with a second SIM of the UE during the MUSIM gap based at least in part on a priority associated with the LP-WUS monitoring occasion and a priority associated with the MUSIM gap.

Some aspects described herein relate to a network node for wireless communication. The network node may include one or more memories and one or more processors coupled to the one or more memories. The one or more processors may be configured to transmit configuration information associated with a first SIM of a UE, wherein the configuration information is associated with configuring at least one of a set of LP-WUS monitoring occasions or a set of MUSIM gaps at the UE. The one or more processors may be configured to selectively transmit, in connection with an LP-WUS monitoring occasion, of the set of LP-WUS monitoring occasions, at least partially overlapping with a MUSIM gap, of the set of MUSIM gaps, an LP-WUS during the LP-WUS monitoring occasion based at least in part on a priority associated with the LP-WUS monitoring occasion and a priority associated with the MUSIM gap, wherein the LP-WUS is transmitted based at least in part on the priority associated with the LP-WUS monitoring occasion comprising a higher priority relative to the priority associated with the MUSIM gap.

Some aspects described herein relate to an apparatus for wireless communication. The apparatus may include means for receiving configuration information associated with a first SIM of the apparatus, wherein the configuration information is associated with configuring at least one of a set of LP-WUS monitoring occasions or a set of MUSIM gaps at the apparatus. The apparatus may include means for skipping, in connection with an LP-WUS monitoring occasion, of the set of LP-WUS monitoring occasions, at least partially overlapping with a MUSIM gap, of the set of MUSIM gaps, LP-WUS monitoring during the LP-WUS monitoring occasion or monitoring for a communication associated with a second SIM of the apparatus during the MUSIM gap based at least in part on a priority associated with the LP-WUS monitoring occasion and a priority associated with the MUSIM gap.

Some aspects described herein relate to an apparatus for wireless communication. The apparatus may include means for transmitting configuration information associated with a first SIM of a UE, wherein the configuration information is associated with configuring at least one of a set of LP-WUS monitoring occasions or a set of MUSIM gaps at the UE. The apparatus may include means for selectively transmitting, in connection with an LP-WUS monitoring occasion, of the set of LP-WUS monitoring occasions, at least partially overlapping with a MUSIM gap, of the set of MUSIM gaps, an LP-WUS during the LP-WUS monitoring occasion based at least in part on a priority associated with the LP-WUS monitoring occasion and a priority associated with the MUSIM gap, wherein the LP-WUS is transmitted based at least in part on the priority associated with the LP-WUS monitoring occasion comprising a higher priority relative to the priority associated with the MUSIM gap.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of connected mode discontinuous reception, in accordance with the present disclosure.

FIG. 5 is a diagram illustrating an example of a low power wake-up signal (LP-WUS) and a low power wake-up radio, in accordance with the present disclosure.

FIG. 6 is a diagram illustrating an example of multiple user subscriber identity module (MUSIM) communications, in accordance with the present disclosure.

FIGS. 7 and 8 are diagrams illustrating an example associated with LP-WUS monitoring with MUSIM gaps, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A wireless communication system may provide for communication between network nodes and user equipments (UEs). These communications may consume some amount of power. For example, a UE may consume a lower amount of power while in a low power state (such as while not connected to a network or while waiting for paging from the network), and may consume a higher amount of power while in a full power state (such as while actively communicating with a network node or while monitoring for control information from the network). Certain components of the UE may consume a significant amount of power. For example, a main radio of the UE, which may support bidirectional communication (such as both transmission and reception), multi-layer communication, or larger bandwidths (such as a communication bandwidth of the UE), may consume power while active, such as in the course of communicating or monitoring for control information.

Some techniques provide power savings at the UE by limiting the amount or ratio of time in which the main radio is active, relative to the amount of time in which the main radio is inactive or powered down. For example, a connected mode discontinuous reception (C-DRX) cycle may provide off durations (sometimes referred to as inactive times, or sleep durations) in which the main radio is inactive, and on durations in which the main radio is active. The UE (using the main radio) may monitor for a physical downlink control channel (PDCCH) during the on duration, and may extend the on duration if a PDCCH is received, which facilitates further communication in accordance with the PDCCH. Thus, power consumption of the main radio may be reduced by reducing the amount of time in which the main radio is active and/or monitoring for a PDCCH.

While the C-DRX cycle reduces power consumption at the UE and the network, further power savings may be desirable, particularly in 5G, 6G, and similar radio access technologies (RATs) where beamforming and high-frequency communication cause increased power consumption relative to other RATs. To achieve further power savings, a UE may include or be associated with a low-power wakeup radio (LP-WUR). The LP-WUR may consume less power than the main radio. The LP-WUR may facilitate indication, from the network, for the UE to exit a low power state, such as by waking up the main radio. For example, while the main radio is in a low power state, the LP-WUR may receive a signal referred to as a low-power wakeup signal (LP-WUS), and may trigger the main radio to exit the low power state. Notably, the LP-WUS/LP-WUR can be implemented in conjunction with a C-DRX cycle, such that the main radio may skip an on duration if the LP-WUR has not received an LP-WUS in association with (e.g., before) the on duration, thereby further reducing power consumption relative to waking up in an on duration in which the UE will not receive a PDCCH.

In some cases, the UE may be configured with a set of monitoring occasions during which the UE monitors for an LP-WUS (e.g., an LP-WUS monitoring occasion). In some cases, an LP-WUS monitoring occasion may occur outside of a C-DRX active time (e.g., outside of a time period during which the UE is in the active state and/or during a time period during which the UE is in the inactive state).

If an LP-WUS is received during an LP-WUS monitoring occasion that occurs outside of the C-DRX active time, the LP-WUS may trigger the UE to perform PDCCH monitoring outside the C-DRX active time. In this way, a network (e.g., a network node) may transmit downlink control information (DCI) scheduling resources for the UE outside of the C-DRX active time, which may reduce a latency associated with communicating data between the UE and the network (e.g., relative to only transmitting DCI scheduling resources for the UE during the C-DRX active time).

In some cases, the UE may communicate using multiple user subscriber identity module (MUSIM) communications. For example, the UE may communicate with a first network (and/or first mobile network operator (MNO)) using a first subscriber identity module (SIM) (for example, SIM A) and may communicate with a second network (and/or second MNO) using a second SIM (for example, SIM B). However, the UE may only communicate on a single network at a given time. For example, a UE that is connected to the first network using SIM A may need to switch to the second network to communicate on the second network using SIM B.

In some cases, to enable the UE to communicate using MUSIM communications, the UE may be configured with one or more MUSIM gaps. A MUSIM gap may be a period of time during which the UE suspends operations in a network (e.g., the first network) and switches to another network (e.g., the second network) to communicate on the other network.

In some cases, the UE may be configured with C-DRX and one or more MUSIM gaps. To prevent a MUSIM gap from occurring during the active time of the C-DRX cycle, the active time may be configured based at least in part on an offset to the MUSIM gap. Stated differently, the one or more MUSIM gaps may be configured to occur outside of the active time of the C-DRX cycle (e.g., during the inactive time). However, because an LP-WUS monitoring occasion may occur outside of an active time of the C-DRX cycle, in some cases an LP-WUS monitoring occasion may collide (e.g., at least partially overlap) with a MUSIM gap.

Various aspects relate generally to handling collisions between an LP-WUS monitoring occasion and a MUSIM gap. Some aspects more specifically relate to handling collisions between an LP-WUS monitoring occasion and a MUSIM gap based at least in part on a priority associated with the LP-WUS monitoring occasion and a priority associated with the MUSIM gap. In some aspects, a MUSIM gap may be prioritized over an LP-WUS monitoring occasion. For example, a UE may skip monitoring for an LP-WUS during an LP-WUS monitoring occasion that overlaps with a MUSIM gap based at least in part on prioritizing the MUSIM gap over the LP-WUS monitoring occasion. Stated differently, the UE may monitor for a communication associated with a second SIM of the UE during the MUSIM gap based at least in part on prioritizing the MUSIM gap over the LP-WUS monitoring occasion.

In some aspects, an LP-WUS monitoring occasion may be prioritized over a MUSIM gap. For example, a UE may skip monitoring for a communication associated with a second SIM of the UE during the MUSIM gap based at least in part on prioritizing the LP-WUS monitoring occasion over the MUSIM gap. Stated differently, the UE may monitor for an LP-WUS during the LP-WUS monitoring period based at least in part on prioritizing the LP-WUS monitoring occasion over the MUSIM gap.

Particular aspects of the subject matter described in this disclosure can be implemented to realize one or more of the following potential advantages. In some examples, by handling collisions between an LP-WUS monitoring occasion and a MUSIM gap based at least in part on a priority associated with the LP-WUS monitoring occasion and a priority associated with the MUSIM gap, the described techniques can be used to selectively prioritize traffic communicated via different SIMs of a UE.

Multiple-access RATs have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

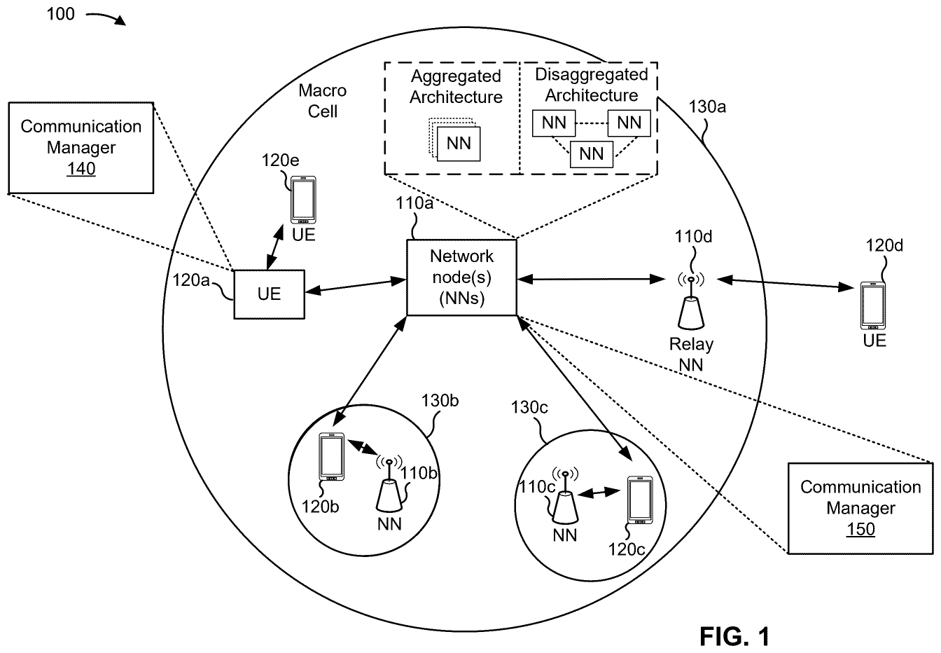

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GH2), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit DCI (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more PDCCHs, and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120c in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE 120 may include a communication manager 140. As described in more detail elsewhere herein, the communication manager 140 may receive configuration information associated with a first SIM of the UE, wherein the configuration information is associated with configuring at least one of a set of LP-WUS monitoring occasions or a set of MUSIM gaps at the UE; and skip, in connection with an LP-WUS monitoring occasion, of the set of LP-WUS monitoring occasions, at least partially overlapping with a MUSIM gap, of the set of MUSIM gaps, LP-WUS monitoring during the LP-WUS monitoring occasion or monitoring for a communication associated with a second SIM of the UE during the MUSIM gap based at least in part on a priority associated with the LP-WUS monitoring occasion and a priority associated with the MUSIM gap. Additionally, or alternatively, the communication manager 140 may perform one or more other operations described herein.

In some aspects, a network node 110 may include a communication manager 150. As described in more detail elsewhere herein, the communication manager 150 may transmit configuration information associated with a first SIM of a UE, wherein the configuration information is associated with configuring at least one of a set of LP-WUS monitoring occasions or a set of MUSIM gaps at the UE; and selectively transmit, in connection with an LP-WUS monitoring occasion, of the set of LP-WUS monitoring occasions, at least partially overlapping with a MUSIM gap, of the set of MUSIM gaps, an LP-WUS during the LP-WUS monitoring occasion based at least in part on a priority associated with the LP-WUS monitoring occasion and a priority associated with the MUSIM gap, wherein the LP-WUS is transmitted based at least in part on the priority associated with the LP-WUS monitoring occasion comprising a higher priority relative to the priority associated with the MUSIM gap. Additionally, or alternatively, the communication manager 150 may perform one or more other operations described herein.

As indicated above, FIG. 1 is provided as an example. Other examples may differ from what is described with regard to FIG. 1.

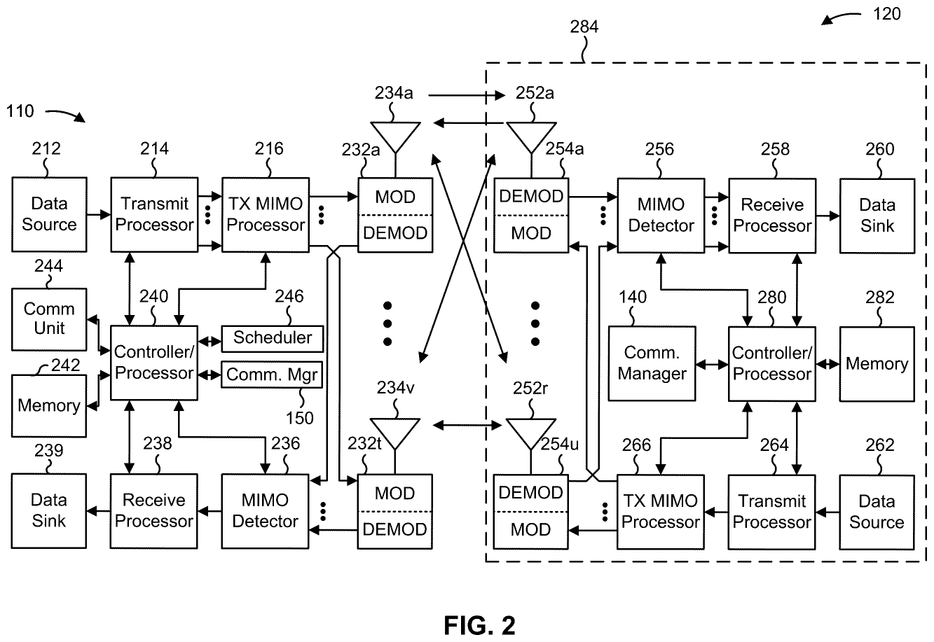

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

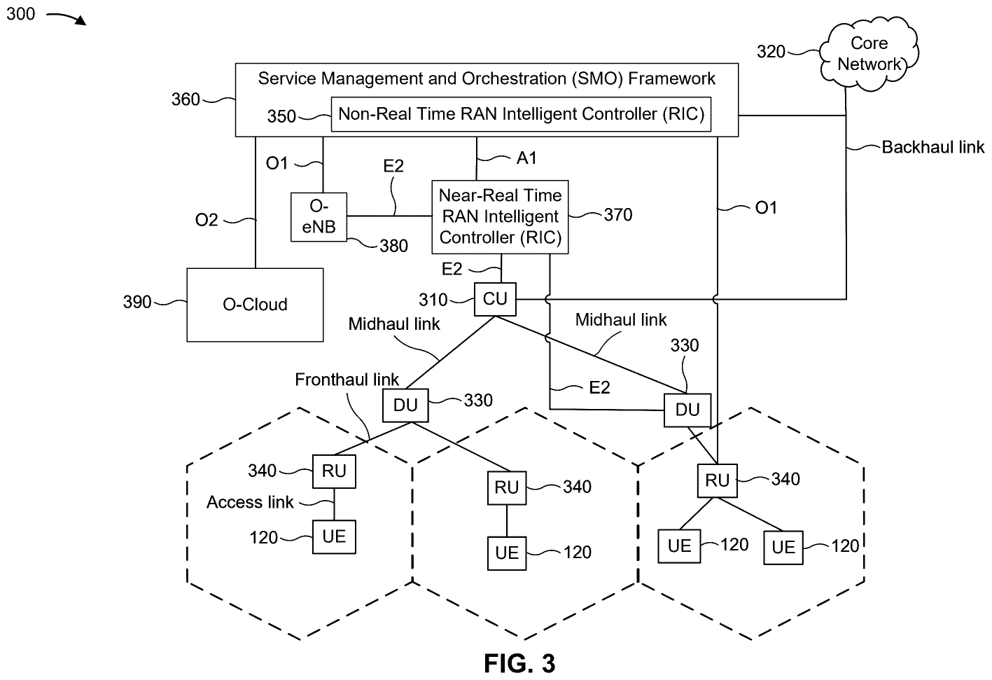

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open cNB (O-cNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

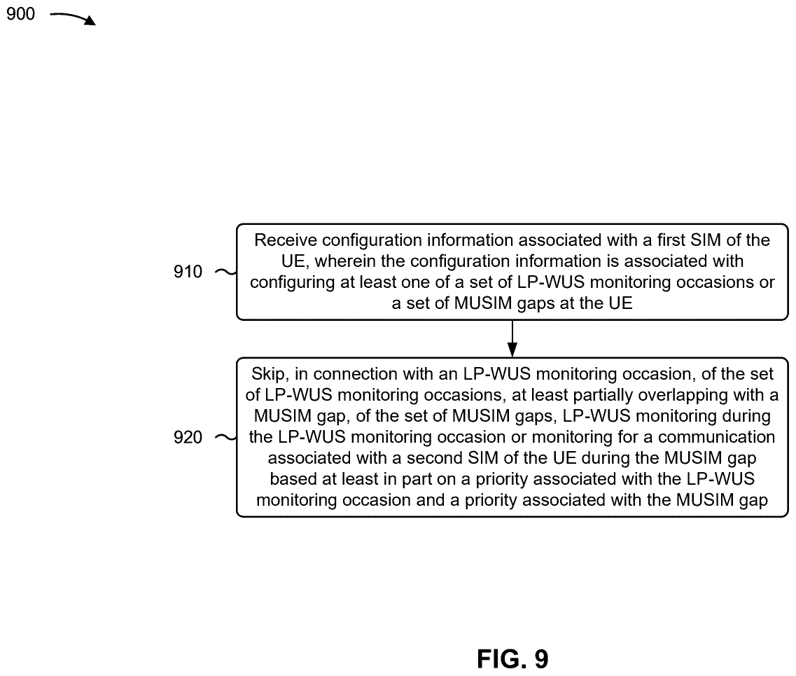

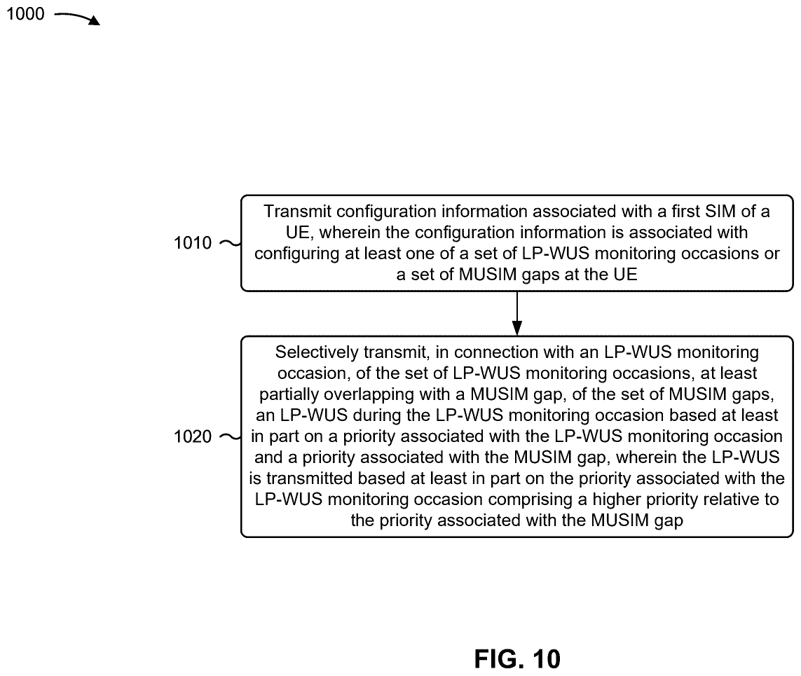

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with LP-WUS monitoring with MUSIM gaps, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects a UE 120 includes means for receiving configuration information associated with a first SIM of the UE, wherein the configuration information is associated with configuring at least one of a set of LP-WUS monitoring occasions or a set of MUSIM gaps at the UE; and/or means for skipping, in connection with an LP-WUS monitoring occasion, of the set of LP-WUS monitoring occasions, at least partially overlapping with a MUSIM gap, of the set of MUSIM gaps, LP-WUS monitoring during the LP-WUS monitoring occasion or monitoring for a communication associated with a second SIM of the UE during the MUSIM gap based at least in part on a priority associated with the LP-WUS monitoring occasion and a priority associated with the MUSIM gap. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node 110 includes means for transmitting configuration information associated with a first SIM of a UE, wherein the configuration information is associated with configuring at least one of a set of LP-WUS monitoring occasions or a set of MUSIM gaps at the UE; and/or means for selectively transmitting, in connection with an LP-WUS monitoring occasion, of the set of LP-WUS monitoring occasions, at least partially overlapping with a MUSIM gap, of the set of MUSIM gaps, an LP-WUS during the LP-WUS monitoring occasion based at least in part on a priority associated with the LP-WUS monitoring occasion and a priority associated with the MUSIM gap, wherein the LP-WUS is transmitted based at least in part on the priority associated with the LP-WUS monitoring occasion comprising a higher priority relative to the priority associated with the MUSIM gap. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

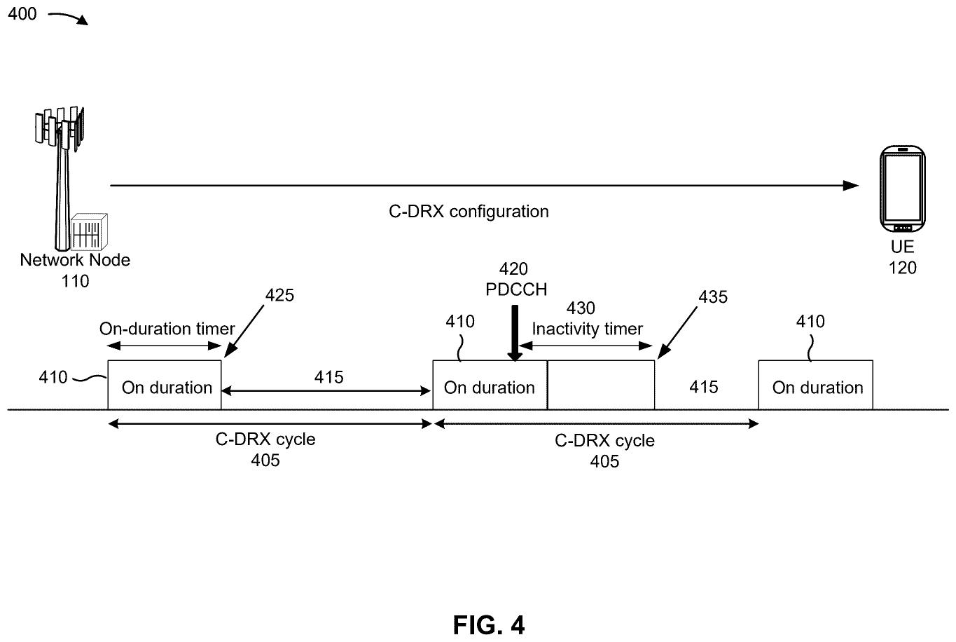

FIG. 4 is a diagram illustrating an example 400 of a C-DRX, in accordance with the present disclosure.

As shown in FIG. 4, a network node 110 may transmit a C-DRX configuration to a connected-mode UE 120 to configure a C-DRX cycle 405 for the UE 120. A C-DRX cycle 405 may include a C-DRX on duration 410 (e.g., during which a UE 120 is awake or in an active state) and an opportunity to enter a C-DRX sleep state 415. As used herein, the time during which the UE 120 is configured to be in an active state during the C-DRX on duration 410 may be referred to as an active time, and the time during which the UE 120 is configured to be in the C-DRX sleep state 415 may be referred to as an inactive time. As described below, the UE 120 may monitor a PDCCH during the active time, and may refrain from monitoring the PDCCH during the inactive time.

During the C-DRX on duration 410 (e.g., the active time), the UE 120 may monitor a downlink control channel (e.g., a PDCCH), as shown by reference number 420. For example, the UE 120 may monitor the PDCCH for DCI pertaining to the UE 120. If the UE 120 does not detect and/or successfully decode any PDCCH communications intended for the UE 120 during the C-DRX on duration 410, then the UE 120 may enter the sleep state 415 (e.g., for the inactive time) at the end of the C-DRX on duration 410, as shown by reference number 425. In this way, the UE 120 may conserve battery power and reduce power consumption. As shown, the C-DRX cycle 405 may repeat with a configured periodicity according to the C-DRX configuration.

If the UE 120 detects and/or successfully decodes a PDCCH communication intended for the UE 120, then the UE 120 may remain in an active state (e.g., awake) for the duration of a C-DRX inactivity timer 430 (e.g., which may extend the active time). The UE 120 may start the C-DRX inactivity timer 430 at a time at which the PDCCH communication is received (e.g., in a transmission time interval (TTI) in which the PDCCH communication is received, such as a slot or a subframe). The UE 120 may remain in the active state until the C-DRX inactivity timer 430 expires, at which time the UE 120 may enter the sleep state 415 (e.g., for the inactive time), as shown by reference number 435. During the duration of the C-DRX inactivity timer 430, the UE 120 may continue to monitor for PDCCH communications, may obtain a downlink data communication (e.g., on a downlink data channel, such as a PDSCH) scheduled by the PDCCH communication, and/or may prepare and/or transmit an uplink communication (e.g., on a PUSCH) scheduled by the PDCCH communication. The UE 120 may restart the C-DRX inactivity timer 430 after each detection of a PDCCH communication for the UE 120 for an initial transmission (e.g., but not for a retransmission). By operating in this manner, the UE 120 may conserve battery power and reduce power consumption by entering the sleep state 415.

As indicated above, FIG. 4 is provided as an example. Other examples may differ from what is described with respect to FIG. 4.

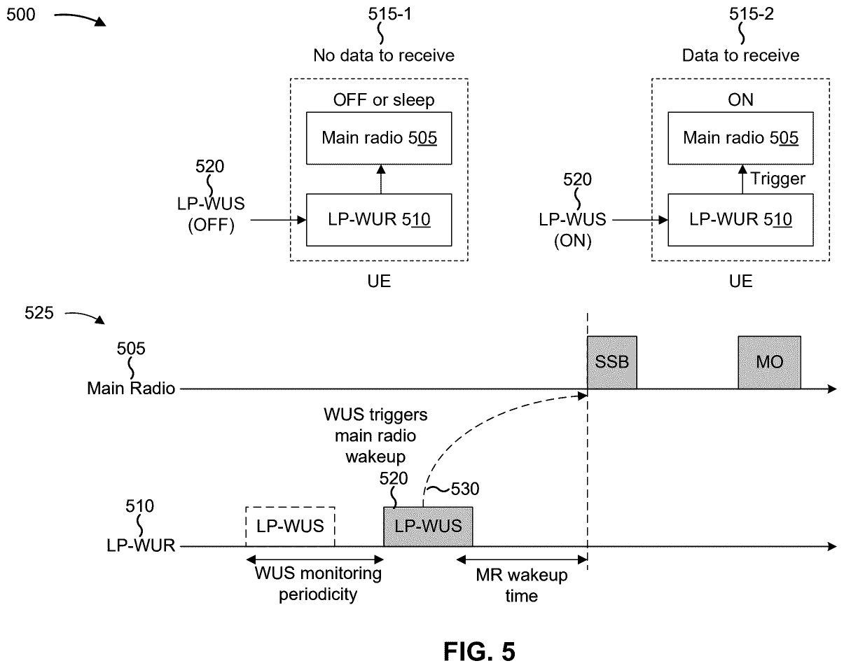

FIG. 5 is a diagram illustrating an example 500 of an LP-WUR and an LP-WUS, in accordance with the present disclosure. As shown in FIG. 5, a UE (such as UE 120) may be equipped with a communication system that includes a main radio (illustrated as “MR”) 505 and an LP-WUR 510 to reduce power consumption and enable low latency. For example, power saving and low latency are often conflicting goals because placing one or more components into a sleep state more often to reduce power consumption also increases latency (e.g., because data cannot be transmitted and/or received while the one or more components are in the sleep state), and because reducing the time that one or more components spend in a sleep state to reduce latency can lead to increased power consumption. Accordingly, as shown in FIG. 5, the UE may be equipped with the LP-WUR 510, which may be considered a companion receiver that can be used with a main radio 505 to reduce power consumption and latency. The LP-WUR 510 may be referred to herein as a “low-power radio” of the UE.

For example, in some examples, the UE may generally use the main radio 505 to transmit and/or receive user data, and the main radio 505 may be turned off or operated in a sleep state unless there is user data to transmit and/or receive. Furthermore, the LP-WUR 510 may serve as a simple wakeup receiver for the main radio 505, and the LP-WUR 510 may be active and monitoring for an LP-WUS while the main radio 505 is off or in the sleep state. For example, reference number 515-1 depicts a first state associated with the main radio 505 and the LP-WUR 510 where there is no user data to be provided to the main radio 505. In such examples, the main radio 505 may be off or operated in the sleep state unless there is user data to transmit, and the LP-WUR 510 may monitor for an LP-WUS (for example, continuously, or periodically in LP-WUS monitoring occasions that are separated in time). Furthermore, reference number 515-2 depicts a second state associated with the main radio 505 and the LP-WUR 510 where there is user data for the main radio 505. In such examples, the LP-WUR 510 may receive an LP-WUS 520 (such as from a network node 110) and may provide a trigger to wake or otherwise activate the main radio 505 based on detecting the LP-WUS 520. Accordingly, the main radio 505 may then transmit and/or receive user data.

In general, the LP-WUR 510 may consume relatively little power (for example a target power consumption less than 100 microwatts (μW) in the active state), which may be achieved using simple modulation schemes (for example, on-off keying (OOK)), a narrow bandwidth (for example, less than 5 MHZ), and/or other suitable techniques. In this way, the LP-WUR 510 can be used to reduce the time that the main radio 505 spends in an on state and/or may avoid unnecessarily waking the main radio 505 from the off or sleep state when there is no user data to transmit or receive, which tends to be costly from a power consumption perspective. Furthermore, because the LP-WUR 510 has a low power consumption, the LP-WUR 510 can be used to frequently or continuously perform LP-WUS monitoring, which may improve latency because the main radio 505 can be woken up when there is user data that the main radio 505 needs to receive. For example, the LP-WUR 510 may not suffer from the latency versus power efficiency tradeoff associated with duty cycling schemes, such as C-DRX.

In some examples, the LP-WUR 510 may include an OOK WUR (also referred to as an envelope detector (ED) WUR). An OOK WUR may only detect the amplitude (such as the magnitude) of a received signal. A UE that uses an OOK WUR may detect the phase of a received signal by activating the main radio 505. In some examples, the LP-WUR 510 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

In some examples, as shown by reference number 525, one application of the LP-WUR 510 may be to monitor the LP-WUS 520 for an LP-WUS indicating that the UE is to monitor for a PDCCH (e.g., DCI scheduling resources for the UE). For example, as shown in FIG. 5, the LP-WUR 510 may be configured to monitor for an LP-WUS 520 (while the main radio 505 is off or in a sleep state or other sleep mode) according to an LP-WUS monitoring periodicity. For example, the LP-WUR 510 may monitor for the LP-WUS 520 in periodic LP-WUS monitoring occasions that are spaced in time according to the LP-WUS monitoring periodicity. Alternatively, although not explicitly shown in FIG. 5, the LP-WUR 510 may be configured to continuously monitor for the LP-WUS 520. As shown by reference number 530, the LP-WUR 510 may receive and detect the LP-WUS 520, which may trigger the LP-WUR 510 to wake up the main radio 505. In some examples, the LP-WUS 520 may be a sequence-based wakeup signal, which may include a predefined set of sequences (implemented, for example, using OOK modulation and/or phase modulation). As shown, the main radio 505 may wake up after a main radio wakeup time, and may then start to monitor one or more synchronization signal block (SSB) transmissions to obtain synchronization with the network node before monitoring and receiving the PDCCH in a subsequent monitoring occasion (MO). Otherwise, in examples where the LP-WUR 510 does not detect the LP-WUS 520, the main radio 505 may remain in the sleep state or other sleep mode to save power.

As indicated above, FIG. 5 is provided as an example. Other examples may differ from what is described with regard to FIG. 5.

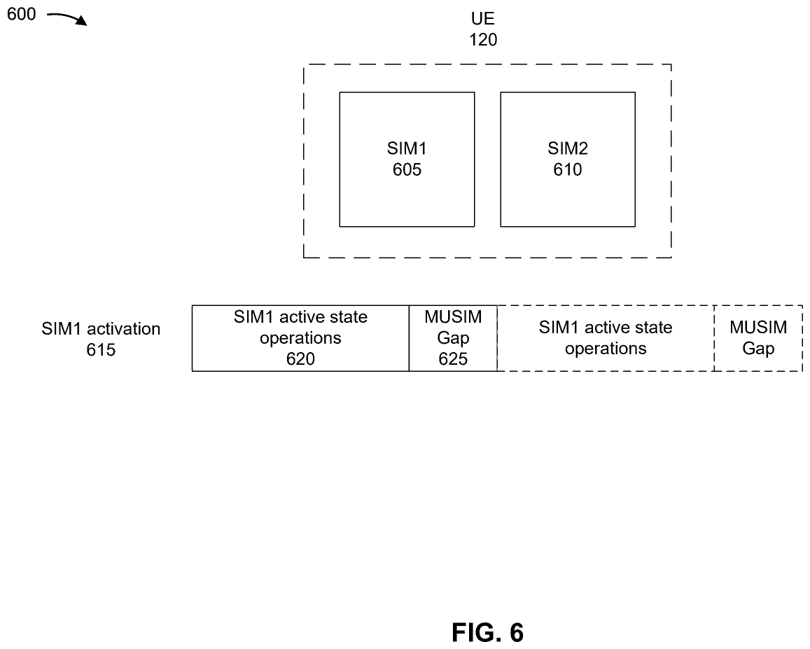

FIG. 6 is a diagram illustrating an example of MUSIM communications, in accordance with the present disclosure. In some cases, the UE 120 may be configured with multiple SIMs. For example, the UE 120 may be configured with a first SIM (SIM1 605) and a second SIM (SIM2 610). In some cases, the SIM1 605 may be associated with a first service provider or a first set of functionalities for the UE 120, and the SIM2 610 may be associated with a second service provider or a second set of functionalities for the UE 120. For example, the UE 120 may use the SIM1 605 for communications using the first service provider or for performing the first set of functionalities, and may use the SIM2 610 for communications using the second service provider or for performing the second set of functionalities.

As shown by reference number 615, the UE 120 may activate the SIM1 605. Thus, the SIM1 605 may be considered to be in an active state. Conversely, the SIM2 610 may be considered to be in an idle state or an inactive state. In some cases, only one SIM of the MUSIM configuration may be in an active state at a given time. In some cases, the UE 120 may be configured to perform one or more active state operations 620 associated with the SIM1 605 while the SIM1 605 is in the active state. For example, the UE 120 may be configured to transmit information or data to, and to receive information or data from, the network node 110 using the SIM1 605 while the SIM1 605 is in the active state.

In some cases, one or more MUSIM gaps 625 may occur between the SIM1 active state operations 620. The MUSIM gaps 625 may occur periodically between the SIM1 active state operations 620 in accordance with a gap pattern. For example, a SIM1 active state operation 620 may occur for a duration X, a MUSIM gap may occur for a duration Y, another SIM1 active state operation 620 may occur for another duration X, and another MUSIM gap may occur for another duration Y, and so on. In some cases, the UE 120 may not be able to perform the SIM1 active state operations 620 (e.g., transmit and receive) during the MUSIM gaps 625. However, the UE 120 may use the MUSIM gaps 625 to perform one or more functions (e.g., limited functions) associated with the SIM2 610. For example, the UE 120 may use the MUSIM gaps 625 to monitor and receive paging, to receive SSBs, and/or to perform idle mode measurements, associated with the SIM2 610.

As indicated above, FIG. 6 is provided as an example. Other examples may differ from what is described with regard to FIG. 6.

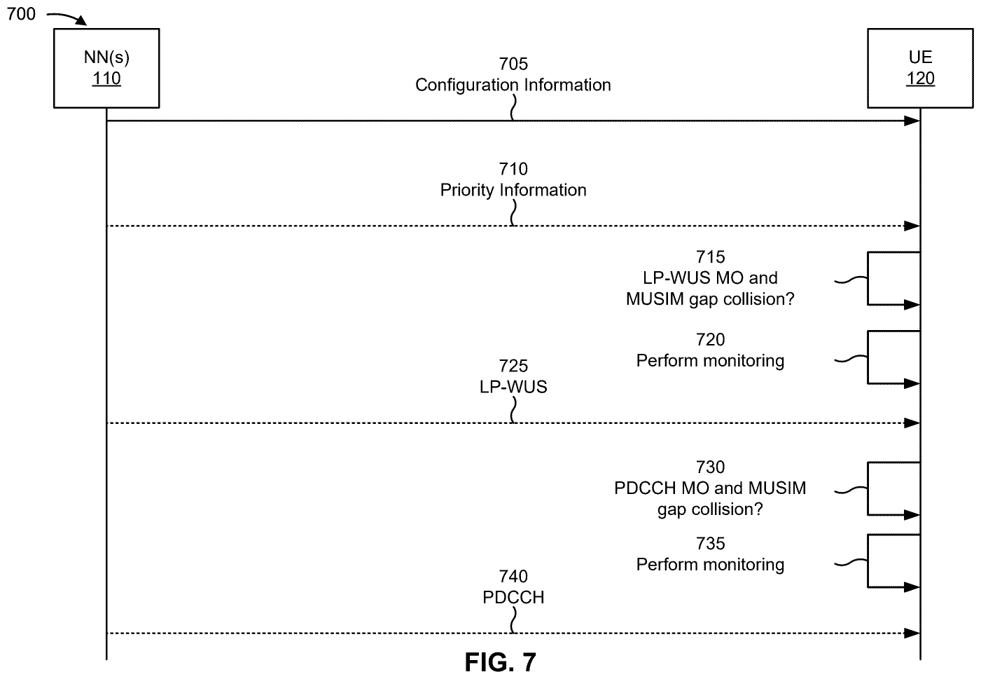

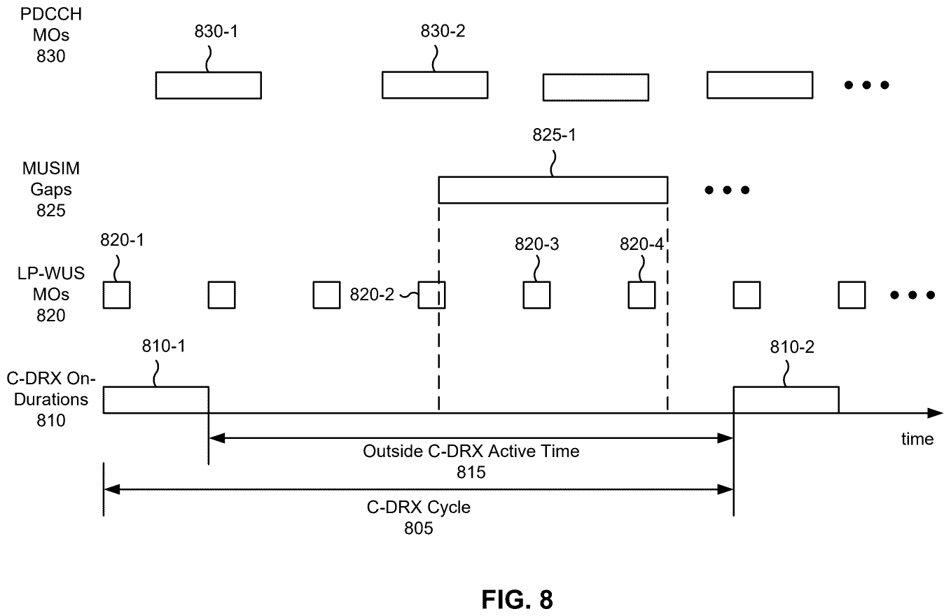

FIGS. 7 and 8 are diagrams illustrating an example 700 associated with LP-WUS monitoring with MUSIM gaps, in accordance with the present disclosure. As shown in FIG. 7, a network node 110 and a UE 120 may communicate with one another. In some aspects, the UE 120 may include multiple SIMs and the network node 110, and the UE 120 may communicate via a network associated with one of the multiple SIMs (e.g., a first SIM).

In some aspects, the UE 120 may communicate with another network node (e.g., another network node 110) and/or the network node 110 using a second SIM of the UE. For example, the UE 120 may communicate with another network node and/or the network node 110 via a second network associated with the second SIM.

As shown by reference number 705, the network node 110 may transmit, and the UE 120 may receive, configuration information. In some aspects, the configuration may include a C-DRX configuration. For example, the network node 110 may transmit a C-DRX configuration to the UE 120 to configure a C-DRX cycle (e.g., C-DRX cycle 805, as shown in FIG. 8). As shown in FIG. 8, the C-DRX cycle 805 may include a C-DRX on duration 810 during which the UE 120 is awake or in an active state. As further shown in FIG. 8, the C-DRX cycle 805 may include an outside C-DRX active time 815 (e.g., an “off duration”).

In some aspects, during the C-DRX on duration 810, the UE 120 may be configured to monitor a downlink control channel (e.g., a PDCCH), as described elsewhere herein. In some aspects, during the off duration, the UE 120 may refrain from monitoring the downlink control channel. For example, the off duration may correspond to an inactive time, as described elsewhere herein.

In some aspects, the configuration information may include LP-WUS configuration information. In some aspects, the LP-WUS configuration and the C-DRX configuration may be included in a same communication (e.g., a same MAC CE and/or a same RRC signaling, among other examples). In some aspects, the LP-WUS configuration may be transmitted separately from the C-DRX configuration.

In some aspects, the LP-WUS configuration may configure the UE 120 with a set of one or more LP-WUS monitoring occasions (e.g., LP-WUS monitoring occasions 820, as shown in FIG. 8). In some aspects, the LP-WUS configuration may indicate an LP-WUS monitoring periodicity to configure the UE 120 with a set of periodic LP-WUS monitoring occasions. In some aspects, during an LP-WUS monitoring occasion the UE 120 may utilize an LP-WUR to monitor for an LP-WUS, as described elsewhere herein.

In some aspects, the LP-WUS configuration may configure the UE 120 with multiple sets of LP-WUS monitoring occasions. For example, the LP-WUS configuration may configure the UE 120 with multiple set of LP-WUS monitoring occasions associated with the same and/or different priorities, as described in greater detail elsewhere herein.

In some aspects, the configuration information may include a MUSIM gap configuration. In some aspects, the MUSIM gap configuration may be included in a same communication as the C-DRX configuration and/or the LP-WUS configuration. In some aspects, the MUSIM gap configuration may be transmitted separately from the C-DRX configuration and/or the LP-WUS configuration.

In some aspects, the MUSIM configuration may configure the UE 120 with a set of one or more MUSIM gaps (e.g., MUSIM gaps 825, as shown in FIG. 8). For example, the configuration information may configure the UE 120 with a set of MUSIM gaps to enable the UE 120 to communicate using another SIM (e.g., the second SIM) via another network, as described elsewhere herein.

In some aspects, the MUSIM configuration may configure the UE 120 with a set of periodic MUSIM gaps. For example, the MUSIM configuration may indicate a MUSIM periodicity to configure the UE 120 with a set of periodic MUSIM gaps.

In some aspects, the set of MUSIM gaps may be configured to occur during the off duration of the C-DRX cycle. For example, the on duration of the C-DRX cycle may be configured based at least in part on an offset to a MUSIM gap.

In some aspects, as shown in FIG. 7 and by reference number 710, the network node 110 may transmit, and the UE 120 may receive priority information. In some aspects, one or more portions of the priority information may be included in, or transmitted in a same communication as, the configuration information. Additionally, or alternatively, one or more portions of the priority information may be transmitted separately from the configuration information.

In some aspects, the priority information may indicate a priority associated with one or more MUSIM gaps configured at the UE. For example, the priority information may include a first value (e.g., in a field associated with the MUSIM gap priority information) to indicate that a MUSIM gap is associated with a first priority (e.g., a high priority) or a second value to indicate that the MUSIM gap is associated with a second priority (e.g., a low priority).

In some aspects, the priority information may indicate the priority associated with a MUSIM gap relative to another priority. For example, the priority information may indicate the priority associated with the MUSIM gap relative to a priority associated with an LP-WUS monitoring occasion, an LP-WUS received during an LP-WUS monitoring occasion, and/or a PDCCH monitoring occasion associated with an LP-WUS monitoring occasion during which an LP-WUS was received.

As an example, the priority information may include a first value (1) (e.g., in a first field associated with the MUSIM gap priority information) to indicate that the priority associated with the MUSIM gap is a higher priority relative to a priority associated with an LP-WUS monitoring occasion. The priority information may include a second value (0) to indicate that the priority associated with the MUSIM gap is a lower priority relative to the priority associated with the LP-WUS monitoring occasion.

As another example, the priority information may include the first value (e.g., in a second field associated with the MUSIM gap priority information) to indicate that the priority associated with the MUSIM gap is a higher priority relative to the priority associated with an LP-WUS received during an LP-WUS monitoring occasion. The priority information may include the second value to indicate that the priority associated with the MUSIM gap is a lower priority relative to the priority associated with the LP-WUS received during the LP-WUS monitoring occasion.

As another example, the priority information may include a first value (e.g., in a third field associated with the MUSIM gap priority information) to indicate that the priority associated with the MUSIM gap is a higher priority relative to the priority associated with a PDCCH monitoring occasion associated with an LP-WUS monitoring occasion during which an LP-WUS was received. The priority information may include the second value to indicate that the priority associated with the MUSIM gap is a lower priority relative to the priority associated with the PDCCH monitoring occasion associated with the LP-WUS monitoring occasion during which the LP-WUS was received.

In some aspects, the priority information may indicate a plurality of priority values associated with a set of MUSIM gaps configured at the UE 120 and/or a MUSIM gap, of the set of MUSIM gaps configured at the UE 120, to which a particular priority value is associated. For example, the priority information may indicate that a first priority value is associated with a first MUSIM gap, a first group of MUSIM gaps, and/or a MUSIM gap that occurs during an on duration (e.g., during an active time) of a C-DRX cycle, among other examples. The priority information may indicate that a second priority value is associated with a second MUSIM gap, a second group of MUSIM gaps, and/or a MUSIM gap that occurs during an off duration (e.g., outside of an active time) of a C-DRX cycle, among other examples.

In some aspects, the priority information may not indicate a priority associated with the one or more MUSIM gaps configured at the UE 120. For example, the UE 120 may be configured to associate the one or more MUSIM gaps with a default priority (e.g., a highest priority, a lowest priority). In some aspects, the one or more MUSIM gaps may be associated with a default priority unless otherwise configured by the network node 110 (e.g., unless the priority information indicates a priority other than the default priority).

In some aspects, the priority information may indicate a priority associated with a set of LP-WUS monitoring occasions configured at the UE 120. In some aspects, the priority information may indicate the priority associated with set of LP-WUS monitoring occasions in a manner similar to that described above with respect to a priority associated with the one or more MUSIM gaps.

In some aspects, multiple LP-WUS configurations may be configured at the UE 120 and the priority information may indicate a priority associated with one or more of the LP-WUS configurations. For example, the priority information may indicate that a first set of the multiple LP-WUS configurations is associated with a first priority (e.g., a highest priority, a higher priority relative to a priority associated with a MUSIM gap) and that a second set of the LP-WUS configuration is associated with a second priority (e.g., a lowest priority, a lower priority relative to a priority associated with a MUSIM gap).

In some aspects, the priority information indicates a priority associated with an LP-WUS received during an LP-WUS monitoring occasion. In some aspects, the priority information indicates a priority associated with an LP-WUS received during an LP-WUS monitoring occasion in a manner similar to that described above.

In some aspects, the priority associated with an LP-WUS received during an LP-WUS monitoring occasion may be the same as a priority associated with the LP-WUS monitoring occasion. For example, the UE 120 may be configured, and/or the priority information may indicate, to associate the priority associated with an LP-WUS received during an LP-WUS monitoring occasion with the priority associated with the LP-WUS monitoring occasion.

In some aspects, the priority associated with an LP-WUS received during an LP-WUS monitoring occasion may be the different from a priority associated with the LP-WUS monitoring occasion. For example, the LP-WUS monitoring occasion may comprise a lowest priority and/or a lower priority relative to a priority associated with a MUSIM gap and the LP-WUS may comprise a highest priority and/or a higher priority relative to a priority associated with a MUSIM gap.

In some aspects, the priority information may indicate a priority associated with a PDCCH monitoring occasion associated with an LP-WUS monitoring occasion during which an LP-WUS is received. In some aspects, the priority information may indicate the priority associated with the priority associated with the PDCCH monitoring occasion in a manner similar to that described above.

In some aspects, the priority associated with the PDCCH monitoring occasion may be the same as a priority associated with an LP-WUS received during an LP-WUS monitoring occasion and/or a priority associated with the LP-WUS monitoring occasion. In some aspects, the priority associated with the PDCCH monitoring occasion may be different from the priority associated with the LP-WUS and/or the priority associated with LP-WUS monitoring occasion.

As shown in FIG. 7, and by reference number 715, the UE 120 may determine whether an LP-WUS monitoring occasion collides with a MUSIM gap. For example, the UE 120 may determine whether an LP-WUS monitoring occasion at least partially overlaps with a MUSIM gap.

In some aspects, as shown in FIG. 8, the UE 120 may be configured with a set of LP-WUS monitoring occasions 820 and a set of MUSIM gaps 825. For example, the UE 120 may identify an LP-WUS monitoring occasion 820 (e.g., based at least in part on the LP-WUS configuration) and a MUSIM gap 825 (e.g., based at least in part on the MUSIM configuration). The UE 120 may determine whether the LP-WUS monitoring occasion 820 at least partially overlaps with the MUSIM gap 825.

In some aspects, the UE 120 may determine that the LP-WUS monitoring occasion 820 does not overlap with the next MUSIM gap 825. For example, the UE 120 may identify LP-WUS monitoring occasion 820-1 as the LP-WUS monitoring occasion 820 and may determine that the LP-WUS monitoring occasion 820-1 does not overlap with a MUSIM gap 825 (e.g., MUSIM gap 825-1, as shown in FIG. 8). The UE 120 may determine to monitor for an LP-WUS during the LP-WUS monitoring occasion 820-1 based at least in part on the LP-WUS monitoring occasion 820-1 not overlapping with a MUSIM gap 825 (e.g., MUSIM gap 825-1).

In some aspects, the UE 120 may determine that the LP-WUS monitoring occasion 820 partially overlaps with a MUSIM gap 825. For example, the UE 120 may determine that LP-WUS monitoring occasion 820-2 partially overlaps with a MUSIM gap 825 (e.g., MUSIM gap 825-1, as shown in FIG. 8).

In some aspects, the UE 120 may determine whether to monitor for an LP-WUS during the LP-WUS monitoring occasion 820-2 based at least in part on a priority associated with the LP-WUS monitoring occasion 820-2 and/or a priority associated with the MUSIM gap 825-1. In some aspects, the priority associated with the LP-WUS monitoring occasion 820-2 may be a higher priority relative to the priority associated with the MUSIM gap 825-1. In these aspects, the UE 120 may determine to monitor for an LP-WUS during the LP-WUS monitoring occasion 820-2 and/or determine to refrain from monitoring for a communication associated with a second SIM of the UE 120 during the MUSIM gap 825-1 based at least in part on the priority associated with the LP-WUS monitoring occasion 820-2 being a higher priority relative to the priority associated with the MUSIM gap 825-1.

In some aspects, the priority associated with the LP-WUS monitoring occasion 820-2 may be a lower priority relative to the priority associated with the MUSIM gap 825-1. In these aspects, the UE 120 may determine to monitor for a communication associated with a second SIM of the UE 120 during the MUSIM gap 825-1 and/or refrain from monitoring for an LP-WUS during the LP-WUS monitoring occasion 820-2 based at least in part on the priority associated with the MUSIM gap 825-1 being a higher priority relative to the priority associated with the LP-WUS monitoring occasion 820-2.

In some aspects, the UE 120 may determine that the LP-WUS monitoring occasion 820 fully overlaps with a MUSIM gap 825. For example, the UE 120 may determine that LP-WUS monitoring occasion 820-3 (and/or 820-4) fully overlaps with a MUSIM gap 825 (e.g., MUSIM gap 825-1, as shown in FIG. 8).

In some aspects, the UE 120 may determine whether to monitor for an LP-WUS during the LP-WUS monitoring occasion 820-3 (and/or 820-4) based at least in part on a priority associated with the LP-WUS monitoring occasion 820-3 (and/or 820-4) and/or a priority associated with the MUSIM gap 825-1. In some aspects, the UE 120 may determine whether to monitor for an LP-WUS during the LP-WUS monitoring occasion 820-3 (and/or 820-4) based at least in part on a priority associated with the LP-WUS monitoring occasion 820-3 (and/or 820-4) and/or a priority associated with the MUSIM gap 825-1 in a manner similar to that described above.

As shown in FIG. 7, and by reference number 720, the UE 120 may perform monitoring based at least in part on one or more of the determinations discussed above. In some aspects, the UE 120 may determine to monitor for a communication associated with a second SIM of the UE 120 during the MUSIM gap 825-1 and/or refrain from monitoring for an LP-WUS during the LP-WUS monitoring occasion 820-2 based at least in part on determining that an LP-WUS monitoring occasion (e.g., LP-WUS monitoring occasion 825-2, 825-3, and/or 825-4) at least partially overlaps with a MUSIM gap (e.g., MUSIM gap 825-1) and based at least in part on the priority associated with the MUSIM gap 825 being a higher priority relative to the priority associated with the LP-WUS monitoring occasion 820.

In some aspects, the UE 120 may monitor for an LP-WUS during an LP-WUS monitoring occasion 820 based at least in part on determining that the LP-WUS monitoring occasion 820 does not overlap with a MUSIM gap 825. For example, the UE 120 may monitor for an LP-WUS during the LP-WUS monitoring occasion 820-1 based at least in part on determining that the LP-WUS monitoring occasion 820-1 does not overlap with a MUSIM gap.

In some aspects, the UE 120 may monitor for an LP-WUS during an LP-WUS monitoring occasion 820 based at least in part on a priority associated with the LP-WUS monitoring occasion 820 being a higher priority relative to a priority associated with a MUSIM gap 825 with which the LP-WUS monitoring occasion at least partially overlaps. For example, the UE 120 may monitor for an LP-WUS during the LP-WUS monitoring occasion 820-2, 820-3, and/or 820-4 based at least in part on determining that a priority associated with the LP-WUS monitoring occasion 820-2, 820-3, and/or 820-4 is a higher priority relative to a priority associated with MUSIM gap 825-1.

In some aspects, the UE 120 may not detect an LP-WUS during the LP-WUS monitoring occasion 820. For example, the network node 110 may not receive (e.g., from another network node 110 and/or another UE 120) data to be transmitted to the UE 120 and may refrain from transmitting an LP-WUS during the LP-WUS monitoring occasion 820.

In some aspects, as shown in FIG. 7, and by reference number 725, the network node 110 may transmit an LP-WUS during the LP-WUS monitoring occasion 820. For example, the network node 110 may receive (e.g., from another network node 110 and/or another UE 120) data to be transmitted to the UE 120 and may transmit an LP-WUS during the LP-WUS monitoring occasion 820 to cause the UE 120 to monitor for a PDCCH during a next PDCCH monitoring occasion 830.

In some aspects, the network node 110 may transmit the LP-WUS during the LP-WUS monitoring occasion 820 further based at least in part on determining that the LP-WUS monitoring occasion does not overlap with a MUSIM gap 825. As an example, the network node 110 may receive data to be transmitted to the UE 120. The network node 110 may determine that the LP-WUS monitoring occasion 820 does not overlap with a MUSIM gap 825. In some aspects, the network node 110 may determine that the LP-WUS monitoring occasion 820 does not overlap with a MUSIM gap 825 in a manner similar to that described above. The network node 110 may transmit an LP-WUS during the LP-WUS monitoring occasion 820 based at least in part on receiving the data to be transmitted to the UE 120 and/or based at least in part on the LP-WUS monitoring occasion 820 does not overlap with a MUSIM gap 825.

In some aspects, the network node 110 may transmit the LP-WUS during the LP-WUS monitoring occasion 820 further based at least in part on determining that the LP-WUS monitoring occasion 820 is associated with a priority that is a higher priority relative to a MUSIM gap 825 with which the LP-WUS monitoring occasion 820 at least partially overlaps. As an example, the network node 110 may receive data to be transmitted to the UE 120. The network node 110 may determine that the LP-WUS monitoring occasion 820 at least partially overlaps with a MUSIM gap 825. In some aspects, the network node 110 may determine that the LP-WUS monitoring occasion 820 at least partially overlaps with a MUSIM gap 825 in a manner similar to that described above.

The network node 110 may determine that LP-WUS monitoring occasion 820 is associated with a priority that is a higher priority relative to a MUSIM gap 825 with which the LP-WUS monitoring occasion 820 at least partially overlaps. In some aspects, the network node 110 may determine that LP-WUS monitoring occasion 820 is associated with a priority that is a higher priority relative to a MUSIM gap 825 with which the LP-WUS monitoring occasion 820 at least partially overlaps in a manner similar to that described above.

The network node 110 may transmit an LP-WUS during the LP-WUS monitoring occasion 820 based at least in part on receiving the data to be transmitted to the UE 120 and/or based at least in part on the network node 110 determining that the LP-WUS monitoring occasion 820 is associated with a priority that is a higher priority relative to the MUSIM gap 825.

In some aspects, the UE 120 may detect and/or receive the LP-WUS during the LP-WUS monitoring occasion 820 based at least in part on monitoring for the LP-WUS during the LP-WUS monitoring occasion 820 (e.g., LP-WUS monitoring occasion 820-1, 820-2, 820-3, or 820-4). In these aspects, the UE 120 may identify a PDCCH monitoring occasion 830 associated with the LP-WUS monitoring occasion 820 during which the LP-WUS was received.

In some aspects, as shown by reference number 730, the UE 120 may determine whether the PDCCH monitoring occasion 830 at least partially overlaps with a MUSIM gap 825. In some aspects, the UE 120 may determine that the PDCCH monitoring occasion 830 does not overlap with a MUSIM gap 825.

For example, the LP-WUS may be detected and/or received during the LP-WUS monitoring occasion 820-1. The LP-WUS monitoring occasion 820-1 may be associated with the PDCCH monitoring occasion 830-1. The UE 120 may determine that the PDCCH monitoring occasion 830-1 does not overlap with a MUSIM gap 825. The UE 120 may monitor for a PDCCH during the PDCCH monitoring occasion 830-1 based at least in part on the PDCCH monitoring occasion 830-1 not overlapping with a MUSIM gap 825.

In some aspects, the UE 120 may determine that the PDCCH monitoring occasion 830 at least partially overlaps with a MUSIM gap 825. For example, the LP-WUS may be detected and/or received during the LP-WUS monitoring occasion 820-1. The LP-WUS monitoring occasion 820-1 may be associated with the PDCCH monitoring occasion 830-2. The UE 120 may determine that the PDCCH monitoring occasion 830-2 partially overlaps with a MUSIM gap 825 (e.g., MUSIM gap 825-1).

In some aspects, the UE 120 may determine whether to monitor for a PDCCH during the PDCCH monitoring occasion 830-2 or to monitor for a communication associated with a second SIM of the UE 120 during the MUSIM gap 825-1 based at least in part on a priority associated with the PDCCH monitoring occasion 830-2 and/or a priority associated with the MUSIM gap 825-1.

In some aspects, the UE 120 may determine that a priority associated with the PDCCH monitoring occasion 830-1 is the same as a priority associated with the LP-WUS monitoring occasion 820-2. In some aspects, the UE 120 may determine that the priority associated with the PDCCH monitoring occasion 830-2 is the same as the priority associated with the LP-WUS monitoring occasion 820-2 based at least in part on the configuration information and/or the priority information received from the network node 110.

For example, the configuration information and/or the priority information may indicate that all PDCCH monitoring occasions 830 inherit (e.g., are the same as) the priority of an LP-WUS monitoring occasion 820 with which they are associated. As another example, the configuration information and/or the priority information may indicate that the PDCCH monitoring occasion 830-2 inherits the priority associated with the LP-WUS monitoring occasion 820-2. As another example, the configuration information and/or the priority information may indicate that the LP-WUS monitoring occasion 820-2 is associated with a first priority and may indicate that the PDCCH monitoring occasion 830-2 is also associated with the first priority.

In some aspects, the configuration and/or the priority information may not indicate a priority associated with the PDCCH monitoring occasion 830-2. The UE 120 may determine that the PDCCH monitoring occasion 830 inherits and/or is the same as the priority associated with the LP-WUS monitoring occasion 820-2 based at least in part on the configuration information and/or the priority information not indicating a priority associated with the PDCCH monitoring occasion 830-2.

In some aspects, the UE 120 may determine that the PDCCH monitoring occasion 830-2 is associated with a highest priority and/or a higher priority relative to the MUSIM gap 825-1 based at least in part on receiving the LP-WUS during the LP-WUS monitoring occasion 820-2. As an example, the LP-WUS monitoring occasion 820-1 may be associated with a lowest priority and/or a lower priority relative to the priority associated with the MUSIM gap 825-1.

The UE 120 may determine that the priority associated with the PDCCH monitoring occasion 830-2 is a highest priority and/or a higher priority relative to the priority associated with the MUSIM gap 825-1 based at least in part on the LP-WUS being detected and/or received during the LP-WUS monitoring occasion 820-2. In this way, the network node 110 may reduce a latency associated with transmitting data to the UE 120 relative to waiting to transmit the data during an on duration of a C-DRX, during a PDCCH monitoring occasion 830 that does not overlap with a MUSIM gap 825, or during a PDCCH monitoring occasion 830 that is associated with a higher priority relative to a priority of a MUSIM gap 825 with which the PDCCH monitoring occasion 830 overlaps.

In some aspects, the UE 120 may determine that the priority associated with the MUSIM gap 825 is a higher priority relative to the priority associated with the PDCCH monitoring occasion 830. The UE 120 may determine to monitor for a communication associated with a second SIM of the UE 120 during the MUSIM gap 825 and/or to refrain from monitoring for a PDCCH during the PDCCH monitoring occasion 830 based at least in part on the priority associated with the MUSIM gap 825 being a higher priority relative to the priority associated with the PDCCH monitoring occasion 830.

In some aspects, the UE 120 may determine that the priority associated with the PDCCH monitoring occasion 830 is a higher priority relative to the priority associated with the MUSIM gap 825. The UE 120 may determine to monitor for a PDCCH during the PDCCH monitoring occasion 830 and/or to refrain from monitoring for a communication associated with a second SIM of the UE 120 during the MUSIM gap 825 based at least in part on the priority associated with the PDCCH monitoring occasion 830 being a higher priority relative to the priority associated with the MUSIM gap 825.

As shown in FIG. 7, and by reference number 735, the UE 120 may perform monitoring based at least in part on the determinations described above. In some aspects, the UE 120 may monitor for a communication associated with a second SIM of the UE 120 during the MUSIM gap 825. For example, the UE 120 may determine that the priority associated with the MUSIM gap 825 is a higher priority relative to the PDCCH monitoring occasion 830. The UE 120 may monitor for a communication associated with a second SIM of the UE 120 during the MUSIM gap 825 based at least in part on the priority associated with the MUSIM gap 825 being a higher priority relative to the PDCCH monitoring occasion 830.

In some aspects, the UE 120 may monitor for the PDCCH based at least in part on an expiration of the MUSIM gap 825. In some aspects, the UE 120 may monitor for the PDCCH in the next PDCCH monitoring occasion 830 after the expiration of the MUSIM gap 825. In some aspects, the UE 120 may monitor for the PDCCH in the next PDCCH monitoring occasion 830 that does not at least partially overlap with a MUSIM gap 825. In some aspects, the UE 120 may monitor for the PDCCH in the next PDCCH monitoring occasion 830 that is associated with a higher priority relative to a priority of a MUSIM gap 825 with which the PDCCH monitoring occasion 830 overlaps.

In some aspects, the UE 120 may not monitor for the PDCCH based at least in part on the expiration of the MUSIM gap 825. In some aspects, the UE 120 may monitor for another LP-WUS during another LP-WUS monitoring occasion 820 in a manner similar to that described above. The UE 120 may monitor for the PDCCH during a PDCCH monitoring occasion 830 based at least in part on receiving the LP-WUS during the LP-WUS monitoring occasion 820.

In some aspects, the UE 120 may monitor for the PDCCH during the PDCCH monitoring occasion 830-1 based at least in part on determining that the PDCCH monitoring occasion 830-1 does not overlap with a MUSIM gap 825. In some aspects, the UE 120 may monitor for the PDCCH during the PDCCH monitoring occasion 830-2 based at least in part on determining that the PDCCH monitoring occasion 830-2 is associated with a higher priority relative to the MUSIM gap 825-1.

In some aspects, the network node 110 may not transmit the PDCCH during the PDCCH monitoring occasion 830. For example, the network node 110 may determine that the PDCCH monitoring occasion 830 at least partially overlaps with a MUSIM gap 825 and/or that the PDCCH monitoring occasion 830 is associated with a lower priority relative to a priority associated with a MUSIM gap 825 which the PDCCH monitoring occasion 830 overlaps in a manner similar to that described above. The network node 110 may refrain from transmitting the PDCCH during the PDCCH monitoring occasion 830 based at least in part on the PDCCH monitoring occasion 830 at least partially overlapping with the MUSIM gap 825 and/or the PDCCH monitoring occasion 830 being associated with a lower priority relative to a priority associated with a MUSIM gap 825 which the PDCCH monitoring occasion 830 overlaps.

In some aspects, as shown by reference number 740, the network node 110 may transmit the PDCCH to the UE 120 during the PDCCH monitoring occasion 830. In some aspects, the network node 110 may determine that the PDCCH monitoring occasion 830 does not overlap with a MUSIM gap 825 in a manner similar to that described above. The network node 110 may transmit the PDCCH to the UE 120 during the PDCCH monitoring occasion 830 based at least in part on the PDCCH monitoring occasion 830 not overlapping with a MUSIM gap 825.

In some aspects, the network node 110 may transmit the PDCCH to the UE 120 during the PDCCH monitoring occasion 830 based at least in part on determining that the PDCCH monitoring occasion 830 is associated with a higher priority relative to a priority associated with the MUSIM gap 825 with which the PDCCH monitoring occasion 830 overlaps.

For example, the network node 110 may determine that the PDCCH monitoring occasion 830 at least partially overlaps with a MUSIM gap 825 and that the PDCCH monitoring occasion 830 is associated with a higher priority relative to a priority associated with the MUSIM gap 825 with which the PDCCH monitoring occasion 830 overlaps in a manner similar to that described above. The network node 110 may transmit the PDCCH to the UE 120 during the PDCCH monitoring occasion 830 based at least in part on the PDCCH monitoring occasion 830 being associated with a higher priority relative to a priority associated with the MUSIM gap 825 with which the PDCCH monitoring occasion 830 overlaps.

As indicated above, FIGS. 7 and 8 provided as an example. Other examples may differ from what is described with respect to FIGS. 7 and 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with LP-WUS monitoring with MUSIM gap.

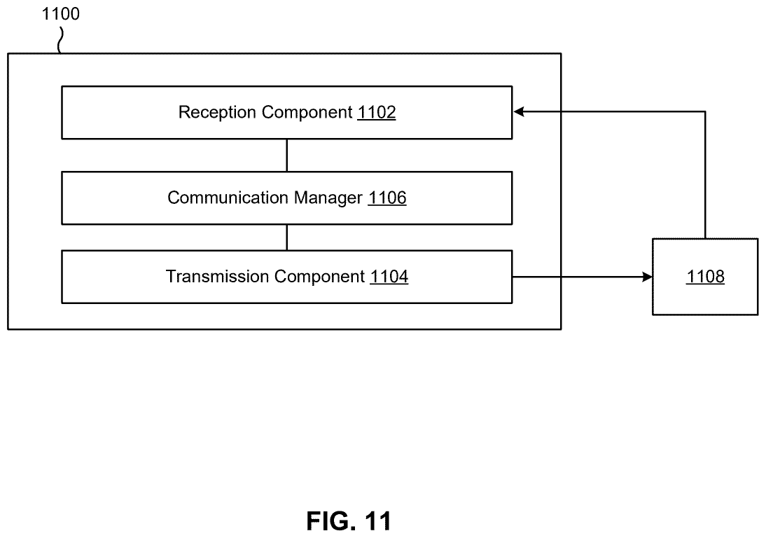

As shown in FIG. 9, in some aspects, process 900 may include receiving configuration information associated with a first SIM of the UE, wherein the configuration information is associated with configuring at least one of a set of LP-WUS monitoring occasions or a set of MUSIM gaps at the UE (block 910). For example, the UE (e.g., using reception component 1102 and/or communication manager 1106, depicted in FIG. 11) may receive configuration information associated with a first SIM of the UE, wherein the configuration information is associated with configuring at least one of a set of LP-WUS monitoring occasions or a set of MUSIM gaps at the UE, as described above.

As further shown in FIG. 9, in some aspects, process 900 may include skipping, in connection with an LP-WUS monitoring occasion, of the set of LP-WUS monitoring occasions, at least partially overlapping with a MUSIM gap, of the set of MUSIM gaps, LP-WUS monitoring during the LP-WUS monitoring occasion or monitoring for a communication associated with a second SIM of the UE during the MUSIM gap based at least in part on a priority associated with the LP-WUS monitoring occasion and a priority associated with the MUSIM gap (block 920). For example, the UE (e.g., using communication manager 1106, depicted in FIG. 11) may skip, in connection with an LP-WUS monitoring occasion, of the set of LP-WUS monitoring occasions, at least partially overlapping with a MUSIM gap, of the set of MUSIM gaps, LP-WUS monitoring during the LP-WUS monitoring occasion or monitoring for a communication associated with a second SIM of the UE during the MUSIM gap based at least in part on a priority associated with the LP-WUS monitoring occasion and a priority associated with the MUSIM gap, as described above.

Process 900 may include additional aspects, such as any single aspect or any combination of aspects described below and/or in connection with one or more other processes described elsewhere herein.

In a first aspect, process 900 includes receiving information indicating the priority associated with the LP-WUS monitoring occasion relative to the priority associated with the MUSIM gap.

In a second aspect, alone or in combination with the first aspect, the information indicates that the priority associated with the LP-WUS monitoring occasion is a higher priority relative to the priority associated with the MUSIM gap.

In a third aspect, alone or in combination with one or more of the first and second aspects, skipping, in connection with the LP-WUS monitoring occasion at least partially overlapping with the MUSIM gap, the LP-WUS monitoring during the LP-WUS monitoring occasion or the MUSIM gap comprises skipping the monitoring for the communication associated with the second SIM of the UE during the MUSIM gap based at least in part on the priority associated with the LP-WUS monitoring occasion being a higher priority relative to the priority associated with the MUSIM gap.

In a fourth aspect, alone or in combination with one or more of the first through third aspects, the LP-WUS monitoring occasion comprises a first LP-WUS monitoring occasion, the method further comprising receiving an LP-WUS during a second LP-WUS monitoring occasion, wherein the second LP-WUS monitoring occasion does not overlap with the MUSIM gap, and wherein the second LP-WUS monitoring occasion is associated with a PDCCH monitoring occasion that at least partially overlaps with the MUSIM gap, and refraining from monitoring for a PDCCH during the PDCCH monitoring occasion.

In a fifth aspect, alone or in combination with one or more of the first through fourth aspects, process 900 includes monitoring, at an end of the MUSIM gap, for the PDCCH.

In a sixth aspect, alone or in combination with one or more of the first through fifth aspects, process 900 includes monitoring, at an end of the MUSIM gap, for another LP-WUS during a subsequent LP-WUS monitoring occasion.

In a seventh aspect, alone or in combination with one or more of the first through sixth aspects, the UE is configured with a first LP-WUS configuration and a second LP-WUS configuration, the method further comprising receiving an indication of a first priority associated with the first LP-WUS configuration and a second priority associated with the second LP-WUS configuration, wherein the second priority is different from the first priority.

In an eighth aspect, alone or in combination with one or more of the first through seventh aspects, process 900 includes receiving an indication of a priority associated with a set of LP-WUS monitoring occasions of an LP-WUS configuration relative to the priority associated with the MUSIM gap.

In a ninth aspect, alone or in combination with one or more of the first through eighth aspects, the priority associated with the set of LP-WUS monitoring occasions of the LP-WUS configuration is a higher priority relative to the priority associated with the MUSIM gap, wherein the method further comprising performing the LP-WUS monitoring during the LP-WUS monitoring occasion based at least in part on the priority associated with the set of LP-WUS monitoring occasions of the LP-WUS configuration being the higher priority relative to the priority associated with the MUSIM gap, and wherein skipping the LP-WUS monitoring during the LP-WUS monitoring occasion or the monitoring for the communication associated with the second SIM of the UE during the MUSIM gap comprises skipping the monitoring for the communication associated with the second SIM of the UE during the MUSIM gap based at least in part on the priority associated with the set of LP-WUS monitoring occasions of the LP-WUS configuration being the higher priority relative to the priority associated with the MUSIM gap.

In a tenth aspect, alone or in combination with one or more of the first through ninth aspects, the priority associated with the set of LP-WUS monitoring occasions of the LP-WUS configuration is a lower priority relative to the priority associated with the MUSIM gap, and wherein skipping the LP-WUS monitoring during the LP-WUS monitoring occasion or the monitoring for the communication associated with the second SIM of the UE during the MUSIM gap comprises skipping the LP-WUS monitoring during the LP-WUS monitoring occasion based at least in part on the priority associated with the set of LP-WUS monitoring occasions of the LP-WUS configuration being the lower priority relative to the priority associated with the MUSIM gap.

In an eleventh aspect, alone or in combination with one or more of the first through tenth aspects, the LP-WUS monitoring occasion is associated with a PDCCH monitoring occasion, and wherein a priority associated with the PDCCH monitoring occasion corresponds to the priority associated with the LP-WUS monitoring occasion based at least in part on the LP-WUS monitoring occasion being associated with the PDCCH monitoring occasion.

In a twelfth aspect, alone or in combination with one or more of the first through eleventh aspects, the LP-WUS monitoring occasion comprises a first LP-WUS monitoring occasion, the method further comprising receiving an LP-WUS during a second LP-WUS monitoring occasion, and wherein the second LP-WUS monitoring occasion is associated with a PDCCH monitoring occasion that at least partially overlaps with the MUSIM gap, and monitoring for the PDCCH during the PDCCH monitoring occasion based at least in part on a priority associated with the second LP-WUS monitoring occasion being a higher priority relative to the priority associated with the MUSIM gap, wherein the monitoring for the communication associated with the second SIM of the UE during the MUSIM gap is skipped based at least in part on the priority associated with the second LP-WUS monitoring occasion being the higher priority relative to the priority associated with the MUSIM gap.

In a thirteenth aspect, alone or in combination with one or more of the first through twelfth aspects, the LP-WUS monitoring occasion comprises a first LP-WUS monitoring occasion, the method further comprising receiving an LP-WUS during a second LP-WUS monitoring occasion, wherein the second LP-WUS monitoring occasion does not overlap with the MUSIM gap, wherein a priority associated with the second LP-WUS monitoring occasion is a lower priority relative to the priority associated with the MUSIM gap, and wherein the second LP-WUS monitoring occasion is associated with a PDCCH monitoring occasion that at least partially overlaps with the MUSIM gap, and monitoring for the PDCCH during the PDCCH monitoring occasion based at least in part on receiving the LP-WUS during the second LP-WUS monitoring occasion, wherein the MUSIM gap is skipped based at least in part on receiving the LP-WUS during the second LP-WUS monitoring occasion.

In a fourteenth aspect, alone or in combination with one or more of the first through thirteenth aspects, skipping, in connection with the LP-WUS monitoring occasion at least partially overlapping with the MUSIM gap, the LP-WUS monitoring during the LP-WUS monitoring occasion or the monitoring for the communication associated with the second SIM of the UE during the MUSIM gap comprises skipping the LP-WUS monitoring during the LP-WUS monitoring occasion based at least in part on the priority associated with the LP-WUS monitoring occasion being a lower priority relative to the priority associated with the MUSIM gap.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with LP-WUS monitoring with MUSIM gap.

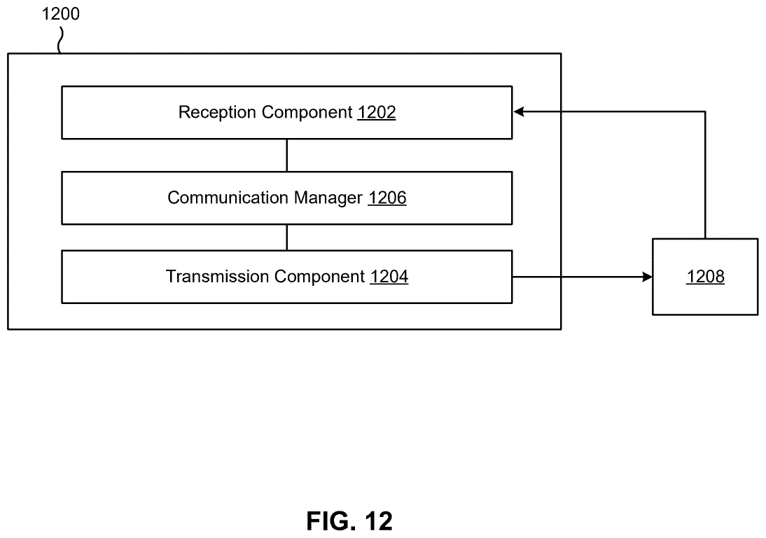

As shown in FIG. 10, in some aspects, process 1000 may include transmitting configuration information associated with a first SIM of a UE, wherein the configuration information is associated with configuring at least one of a set of LP-WUS monitoring occasions or a set of MUSIM gaps at the UE (block 1010). For example, the network node (e.g., using transmission component 1204 and/or communication manager 1206, depicted in FIG. 12) may transmit configuration information associated with a first SIM of a UE, wherein the configuration information is associated with configuring at least one of a set of LP-WUS monitoring occasions or a set of MUSIM gaps at the UE, as described above.

As further shown in FIG. 10, in some aspects, process 1000 may include selectively transmitting, in connection with an LP-WUS monitoring occasion, of the set of LP-WUS monitoring occasions, at least partially overlapping with a MUSIM gap, of the set of MUSIM gaps, an LP-WUS during the LP-WUS monitoring occasion based at least in part on a priority associated with the LP-WUS monitoring occasion and a priority associated with the MUSIM gap, wherein the LP-WUS is transmitted based at least in part on the priority associated with the LP-WUS monitoring occasion comprising a higher priority relative to the priority associated with the MUSIM gap (block 1020). For example, the network node (e.g., using transmission component 1204 and/or communication manager 1206, depicted in FIG. 12) may selectively transmit, in connection with an LP-WUS monitoring occasion, of the set of LP-WUS monitoring occasions, at least partially overlapping with a MUSIM gap, of the set of MUSIM gaps, an LP-WUS during the LP-WUS monitoring occasion based at least in part on a priority associated with the LP-WUS monitoring occasion and a priority associated with the MUSIM gap, wherein the LP-WUS is transmitted based at least in part on the priority associated with the LP-WUS monitoring occasion comprising a higher priority relative to the priority associated with the MUSIM gap, as described above.

Process 1000 may include additional aspects, such as any single aspect or any combination of aspects described below and/or in connection with one or more other processes described elsewhere herein.

In a first aspect, process 1000 includes transmitting information indicating the priority associated with the LP-WUS monitoring occasion relative to the priority associated with the MUSIM gap.

In a second aspect, alone or in combination with the first aspect, the LP-WUS monitoring occasion comprises a first LP-WUS monitoring occasion, the method further comprising transmitting an LP-WUS during a second LP-WUS monitoring occasion, wherein the second LP-WUS monitoring occasion does not overlap with the MUSIM gap, and wherein the second LP-WUS monitoring occasion is associated with a PDCCH monitoring occasion that at least partially overlaps with the MUSIM gap, and refraining from transmitting a PDCCH during the PDCCH monitoring occasion.

In a third aspect, alone or in combination with one or more of the first and second aspects, process 1000 includes transmitting, at an end of the MUSIM gap, the PDCCH.

In a fourth aspect, alone or in combination with one or more of the first through third aspects, process 1000 includes transmitting, at an end of the MUSIM gap, another LP-WUS during a subsequent LP-WUS monitoring occasion.

In a fifth aspect, alone or in combination with one or more of the first through fourth aspects, the UE is configured with a first LP-WUS configuration and a second LP-WUS configuration, the method further comprising transmitting an indication of a first priority associated with the first LP-WUS configuration and a second priority associated with the second LP-WUS configuration, wherein the second priority is different from the first priority.

In a sixth aspect, alone or in combination with one or more of the first through fifth aspects, process 1000 includes transmitting an indication of a priority associated with a set of LP-WUS monitoring occasions of an LP-WUS configuration relative to the priority associated with the MUSIM gap.

In a seventh aspect, alone or in combination with one or more of the first through sixth aspects, the priority associated with the set of LP-WUS monitoring occasions of the LP-WUS configuration is a higher priority relative to the priority associated with the MUSIM gap, wherein the method further comprising transmitting the LP-WUS during the LP-WUS monitoring occasion based at least in part on the priority associated with the set of LP-WUS monitoring occasions of the LP-WUS configuration being the higher priority relative to the priority associated with the MUSIM gap.

In an eighth aspect, alone or in combination with one or more of the first through seventh aspects, the LP-WUS monitoring occasion is associated with a PDCCH monitoring occasion, and wherein a priority associated with the PDCCH monitoring occasion corresponds to the priority associated with the LP-WUS monitoring occasion based at least in part on the LP-WUS monitoring occasion being associated with the PDCCH monitoring occasion.

In a ninth aspect, alone or in combination with one or more of the first through eighth aspects, the LP-WUS monitoring occasion comprises a first LP-WUS monitoring occasion, the method further comprising transmitting an LP-WUS during a second LP-WUS monitoring occasion, wherein the second LP-WUS monitoring occasion does not overlap with the MUSIM gap, wherein a priority associated with the second LP-WUS monitoring occasion is a lower priority relative to the priority associated with the MUSIM gap, and wherein the second LP-WUS monitoring occasion is associated with a PDCCH monitoring occasion that at least partially overlaps with the MUSIM gap, and transmitting the PDCCH during the PDCCH monitoring occasion based at least in part on transmitting the LP-WUS during the second LP-WUS monitoring occasion.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7 and 8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive configuration information associated with a first SIM of the UE, wherein the configuration information is associated with configuring at least one of a set of LP-WUS monitoring occasions or a set of MUSIM gaps at the UE. The communication manager 1106 may skip, in connection with an LP-WUS monitoring occasion, of the set of LP-WUS monitoring occasions, at least partially overlapping with a MUSIM gap, of the set of MUSIM gaps, LP-WUS monitoring during the LP-WUS monitoring occasion or monitoring for a communication associated with a second SIM of the UE during the MUSIM gap based at least in part on a priority associated with the LP-WUS monitoring occasion and a priority associated with the MUSIM gap.

The reception component 1102 may receive information indicating the priority associated with the LP-WUS monitoring occasion relative to the priority associated with the MUSIM gap.

The communication manager 1106 may monitor, at an end of the MUSIM gap, for the PDCCH.

The communication manager 1106 may monitor, at an end of the MUSIM gap, for another LP-WUS during a subsequent LP-WUS monitoring occasion.

The reception component 1102 may receive an indication of a priority associated with a set of LP-WUS monitoring occasions of an LP-WUS configuration relative to the priority associated with the MUSIM gap.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7 and 8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit configuration information associated with a first SIM of a UE, wherein the configuration information is associated with configuring at least one of a set of LP-WUS monitoring occasions or a set of MUSIM gaps at the UE. The transmission component 1204 may selectively transmit, in connection with an LP-WUS monitoring occasion, of the set of LP-WUS monitoring occasions, at least partially overlapping with a MUSIM gap, of the set of MUSIM gaps, an LP-WUS during the LP-WUS monitoring occasion based at least in part on a priority associated with the LP-WUS monitoring occasion and a priority associated with the MUSIM gap, wherein the LP-WUS is transmitted based at least in part on the priority associated with the LP-WUS monitoring occasion comprising a higher priority relative to the priority associated with the MUSIM gap.

The transmission component 1204 may transmit information indicating the priority associated with the LP-WUS monitoring occasion relative to the priority associated with the MUSIM gap.

The transmission component 1204 may transmit, at an end of the MUSIM gap, the PDCCH.

The transmission component 1204 may transmit, at an end of the MUSIM gap, another LP-WUS during a subsequent LP-WUS monitoring occasion.

The transmission component 1204 may transmit an indication of a priority associated with a set of LP-WUS monitoring occasions of an LP-WUS configuration relative to the priority associated with the MUSIM gap.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: receiving configuration information associated with a first SIM of the UE, wherein the configuration information is associated with configuring at least one of a set of LP-WUS monitoring occasions or a set of MUSIM gaps at the UE; and skipping, in connection with an LP-WUS monitoring occasion, of the set of LP-WUS monitoring occasions, at least partially overlapping with a MUSIM gap, of the set of MUSIM gaps, LP-WUS monitoring during the LP-WUS monitoring occasion or monitoring for a communication associated with a second SIM of the UE during the MUSIM gap based at least in part on a priority associated with the LP-WUS monitoring occasion and a priority associated with the MUSIM gap.

Aspect 2: The method of Aspect 1, further comprising receiving information indicating the priority associated with the LP-WUS monitoring occasion relative to the priority associated with the MUSIM gap.

Aspect 3: The method of Aspect 2, wherein the information indicates that the priority associated with the LP-WUS monitoring occasion is a higher priority relative to the priority associated with the MUSIM gap.

Aspect 4: The method of Aspect 3, wherein skipping, in connection with the LP-WUS monitoring occasion at least partially overlapping with the MUSIM gap, the LP-WUS monitoring during the LP-WUS monitoring occasion or the MUSIM gap comprises skipping the monitoring for the communication associated with the second SIM of the UE during the MUSIM gap based at least in part on the priority associated with the LP-WUS monitoring occasion being a higher priority relative to the priority associated with the MUSIM gap.

Aspect 5: The method of any of Aspects 1-4, wherein the LP-WUS monitoring occasion comprises a first LP-WUS monitoring occasion, the method further comprising receiving an LP-WUS during a second LP-WUS monitoring occasion, the second LP-WUS monitoring occasion does not overlap with the MUSIM gap, and wherein the second LP-WUS monitoring occasion is associated with a PDCCH monitoring occasion that at least partially overlaps with the MUSIM gap; and refraining from monitoring for a PDCCH during the PDCCH monitoring occasion.

Aspect 6: The method of Aspect 5, further comprising monitoring, at an end of the MUSIM gap, for the PDCCH.

Aspect 7: The method of Aspect 5, further comprising monitoring, at an end of the MUSIM gap, for another LP-WUS during a subsequent LP-WUS monitoring occasion.

Aspect 8: The method of any of Aspects 1-7, wherein the UE is configured with a first LP-WUS configuration and a second LP-WUS configuration, the method further comprising receiving an indication of a first priority associated with the first LP-WUS configuration and a second priority associated with the second LP-WUS configuration, the second priority is different from the first priority.

Aspect 9: The method of any of Aspects 1-8, further comprising receiving an indication of a priority associated with a set of LP-WUS monitoring occasions of an LP-WUS configuration relative to the priority associated with the MUSIM gap.

Aspect 10: The method of Aspect 9, wherein the priority associated with the set of LP-WUS monitoring occasions of the LP-WUS configuration is a higher priority relative to the priority associated with the MUSIM gap, the method further comprising performing the LP-WUS monitoring during the LP-WUS monitoring occasion based at least in part on the priority associated with the set of LP-WUS monitoring occasions of the LP-WUS configuration being the higher priority relative to the priority associated with the MUSIM gap; and wherein skipping the LP-WUS monitoring during the LP-WUS monitoring occasion or the monitoring for the communication associated with the second SIM of the UE during the MUSIM gap comprises skipping the monitoring for the communication associated with the second SIM of the UE during the MUSIM gap based at least in part on the priority associated with the set of LP-WUS monitoring occasions of the LP-WUS configuration being the higher priority relative to the priority associated with the MUSIM gap.

Aspect 11: The method of Aspect 9, wherein the priority associated with the set of LP-WUS monitoring occasions of the LP-WUS configuration is a lower priority relative to the priority associated with the MUSIM gap, and wherein skipping the LP-WUS monitoring during the LP-WUS monitoring occasion or the monitoring for the communication associated with the second SIM of the UE during the MUSIM gap comprises skipping the LP-WUS monitoring during the LP-WUS monitoring occasion based at least in part on the priority associated with the set of LP-WUS monitoring occasions of the LP-WUS configuration being the lower priority relative to the priority associated with the MUSIM gap.

Aspect 12: The method of any of Aspects 1-11, wherein the LP-WUS monitoring occasion is associated with a PDCCH monitoring occasion, and a priority associated with the PDCCH monitoring occasion corresponds to the priority associated with the LP-WUS monitoring occasion based at least in part on the LP-WUS monitoring occasion being associated with the PDCCH monitoring occasion.

Aspect 13: The method of Aspect 12, wherein the LP-WUS monitoring occasion comprises a first LP-WUS monitoring occasion, the method further comprising receiving an LP-WUS during a second LP-WUS monitoring occasion, and the second LP-WUS monitoring occasion is associated with a PDCCH monitoring occasion that at least partially overlaps with the MUSIM gap; and monitoring for the PDCCH during the PDCCH monitoring occasion based at least in part on a priority associated with the second LP-WUS monitoring occasion being a higher priority relative to the priority associated with the MUSIM gap, the monitoring for the communication associated with the second SIM of the UE during the MUSIM gap is skipped based at least in part on the priority associated with the second LP-WUS monitoring occasion being the higher priority relative to the priority associated with the MUSIM gap.

Aspect 14: The method of any of Aspects 1-13, wherein the LP-WUS monitoring occasion comprises a first LP-WUS monitoring occasion, the method further comprising receiving an LP-WUS during a second LP-WUS monitoring occasion, the second LP-WUS monitoring occasion does not overlap with the MUSIM gap, a priority associated with the second LP-WUS monitoring occasion is a lower priority relative to the priority associated with the MUSIM gap, and the second LP-WUS monitoring occasion is associated with a PDCCH monitoring occasion that at least partially overlaps with the MUSIM gap; and monitoring for the PDCCH during the PDCCH monitoring occasion based at least in part on receiving the LP-WUS during the second LP-WUS monitoring occasion, the MUSIM gap is skipped based at least in part on receiving the LP-WUS during the second LP-WUS monitoring occasion.

Aspect 15: The method of any of Aspects 1-14, wherein skipping, in connection with the LP-WUS monitoring occasion at least partially overlapping with the MUSIM gap, the LP-WUS monitoring during the LP-WUS monitoring occasion or the monitoring for the communication associated with the second SIM of the UE during the MUSIM gap comprises skipping the LP-WUS monitoring during the LP-WUS monitoring occasion based at least in part on the priority associated with the LP-WUS monitoring occasion being a lower priority relative to the priority associated with the MUSIM gap.

Aspect 16: A method of wireless communication performed by a network node, comprising: transmitting configuration information associated with a first SIM of a UE, wherein the configuration information is associated with configuring at least one of a set of LP-WUS monitoring occasions or a set of MUSIM gaps at the UE; and selectively transmitting, in connection with an LP-WUS monitoring occasion, of the set of LP-WUS monitoring occasions, at least partially overlapping with a MUSIM gap, of the set of MUSIM gaps, an LP-WUS during the LP-WUS monitoring occasion based at least in part on a priority associated with the LP-WUS monitoring occasion and a priority associated with the MUSIM gap, the LP-WUS is transmitted based at least in part on the priority associated with the LP-WUS monitoring occasion comprising a higher priority relative to the priority associated with the MUSIM gap.

Aspect 17: The method of Aspect 16, further comprising transmitting information indicating the priority associated with the LP-WUS monitoring occasion relative to the priority associated with the MUSIM gap.

Aspect 18: The method of any of Aspects 16-17, wherein the LP-WUS monitoring occasion comprises a first LP-WUS monitoring occasion, the method further comprising transmitting an LP-WUS during a second LP-WUS monitoring occasion, the second LP-WUS monitoring occasion does not overlap with the MUSIM gap, and the second LP-WUS monitoring occasion is associated with a PDCCH monitoring occasion that at least partially overlaps with the MUSIM gap; and refraining from transmitting a PDCCH during the PDCCH monitoring occasion.

Aspect 19: The method of Aspect 18, further comprising transmitting, at an end of the MUSIM gap, the PDCCH.

Aspect 20: The method of Aspect 18, further comprising transmitting, at an end of the MUSIM gap, another LP-WUS during a subsequent LP-WUS monitoring occasion.

Aspect 21: The method of any of Aspects 16-20, wherein the UE is configured with a first LP-WUS configuration and a second LP-WUS configuration, the method further comprising transmitting an indication of a first priority associated with the first LP-WUS configuration and a second priority associated with the second LP-WUS configuration, the second priority is different from the first priority.

Aspect 22: The method of any of Aspects 16-21, further comprising transmitting an indication of a priority associated with a set of LP-WUS monitoring occasions of an LP-WUS configuration relative to the priority associated with the MUSIM gap.

Aspect 23: The method of Aspect 22, wherein the priority associated with the set of LP-WUS monitoring occasions of the LP-WUS configuration is a higher priority relative to the priority associated with the MUSIM gap, the method further comprising transmitting the LP-WUS during the LP-WUS monitoring occasion based at least in part on the priority associated with the set of LP-WUS monitoring occasions of the LP-WUS configuration being the higher priority relative to the priority associated with the MUSIM gap.

Aspect 24: The method of any of Aspects 16-23, wherein the LP-WUS monitoring occasion is associated with a PDCCH monitoring occasion, and wherein a priority associated with the PDCCH monitoring occasion corresponds to the priority associated with the LP-WUS monitoring occasion based at least in part on the LP-WUS monitoring occasion being associated with the PDCCH monitoring occasion.

Aspect 25: The method of any of Aspects 16-24, wherein the LP-WUS monitoring occasion comprises a first LP-WUS monitoring occasion, the method further comprising transmitting an LP-WUS during a second LP-WUS monitoring occasion, the second LP-WUS monitoring occasion does not overlap with the MUSIM gap, a priority associated with the second LP-WUS monitoring occasion is a lower priority relative to the priority associated with the MUSIM gap, and the second LP-WUS monitoring occasion is associated with a PDCCH monitoring occasion that at least partially overlaps with the MUSIM gap; and transmitting the PDCCH during the PDCCH monitoring occasion based at least in part on transmitting the LP-WUS during the second LP-WUS monitoring occasion.

Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.

Aspect 27: An apparatus for wireless communication at a device, the apparatus comprising one or more memories and one or more processors coupled to the one or more memories, the one or more processors configured to cause the device to perform the method of one or more of Aspects 1-25.

Aspect 28: An apparatus for wireless communication, the apparatus comprising at least one means for performing the method of one or more of Aspects 1-25.

Aspect 29: A non-transitory computer-readable medium storing code for wireless communication, the code comprising instructions executable by one or more processors to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

Aspect 31: A device for wireless communication, the device comprising a processing system that includes one or more processors and one or more memories coupled with the one or more processors, the processing system configured to cause the device to perform the method of one or more of Aspects 1-25.

Aspect 32: An apparatus for wireless communication at a device, the apparatus comprising one or more memories and one or more processors coupled to the one or more memories, the one or more processors individually or collectively configured to cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive configuration information associated with a first subscriber identity module (SIM) of the UE, wherein the configuration information is associated with configuring at least one of a set of low power wake-up signal (LP-WUS) monitoring occasions or a set of multiple user SIM (MUSIM) gaps at the UE; and
skip, in connection with an LP-WUS monitoring occasion, of the set of LP-WUS monitoring occasions, at least partially overlapping with a MUSIM gap, of the set of MUSIM gaps, LP-WUS monitoring during the LP-WUS monitoring occasion or monitoring for a communication associated with a second SIM of the UE during the MUSIM gap based at least in part on a priority associated with the LP-WUS monitoring occasion and a priority associated with the MUSIM gap.

2. The UE of claim 1, wherein the one or more processors are further configured to cause the UE to:
receive information indicating the priority associated with the LP-WUS monitoring occasion relative to the priority associated with the MUSIM gap.

3. The UE of claim 2, wherein the information indicates that the priority associated with the LP-WUS monitoring occasion is a higher priority relative to the priority associated with the MUSIM gap.

4. The UE of claim 3, wherein the one or more processors, to cause the UE to skip, in connection with the LP-WUS monitoring occasion at least partially overlapping with the MUSIM gap, the LP-WUS monitoring during the LP-WUS monitoring occasion or the MUSIM gap, are configured to cause the UE to:
skip the monitoring for the communication associated with the second SIM of the UE during the MUSIM gap based at least in part on the priority associated with the LP-WUS monitoring occasion being a higher priority relative to the priority associated with the MUSIM gap.

5. The UE of claim 1, wherein the LP-WUS monitoring occasion comprises a first LP-WUS monitoring occasion, and wherein the one or more processors are further configured to cause the UE to:
receive an LP-WUS during a second LP-WUS monitoring occasion, wherein the second LP-WUS monitoring occasion does not overlap with the MUSIM gap, and wherein the second LP-WUS monitoring occasion is associated with a physical downlink control channel (PDCCH) monitoring occasion that at least partially overlaps with the MUSIM gap; and
refrain from monitoring for a PDCCH during the PDCCH monitoring occasion.

6. The UE of claim 5, wherein the one or more processors are further configured to cause the UE to:
monitor, at an end of the MUSIM gap, for the PDCCH.

7. The UE of claim 5, wherein the one or more processors are further configured to cause the UE to:
monitor, at an end of the MUSIM gap, for another LP-WUS during a subsequent LP-WUS monitoring occasion.

8. The UE of claim 1, wherein the UE is configured with a first LP-WUS configuration and a second LP-WUS configuration, and wherein the one or more processors are further configured to cause the UE to:
receive an indication of a first priority associated with the first LP-WUS configuration and a second priority associated with the second LP-WUS configuration, wherein the second priority is different from the first priority.

9. The UE of claim 1, wherein the one or more processors are further configured to cause the UE to:
receive an indication of a priority associated with a set of LP-WUS monitoring occasions of an LP-WUS configuration relative to the priority associated with the MUSIM gap.

10. The UE of claim 9, wherein the priority associated with the set of LP-WUS monitoring occasions of the LP-WUS configuration is a higher priority relative to the priority associated with the MUSIM gap, and wherein the one or more processors are further configured to cause the UE to:
perform the LP-WUS monitoring during the LP-WUS monitoring occasion based at least in part on the priority associated with the set of LP-WUS monitoring occasions of the LP-WUS configuration being the higher priority relative to the priority associated with the MUSIM gap; and
wherein the one or more processors, to cause the UE to skip the LP-WUS monitoring during the LP-WUS monitoring occasion or the monitoring for the communication associated with the second SIM of the UE during the MUSIM gap, are configured to cause the UE to:
skip the monitoring for the communication associated with the second SIM of the UE during the MUSIM gap based at least in part on the priority associated with the set of LP-WUS monitoring occasions of the LP-WUS configuration being the higher priority relative to the priority associated with the MUSIM gap.

11. The UE of claim 9, wherein the priority associated with the set of LP-WUS monitoring occasions of the LP-WUS configuration is a lower priority relative to the priority associated with the MUSIM gap, and
wherein the one or more processors, to cause the UE to skip the LP-WUS monitoring during the LP-WUS monitoring occasion or the monitoring for the communication associated with the second SIM of the UE during the MUSIM gap, are configured to cause the UE to:
skip the LP-WUS monitoring during the LP-WUS monitoring occasion based at least in part on the priority associated with the set of LP-WUS monitoring occasions of the LP-WUS configuration being the lower priority relative to the priority associated with the MUSIM gap.

12. The UE of claim 1, wherein the LP-WUS monitoring occasion is associated with a physical downlink control channel (PDCCH) monitoring occasion, and wherein a priority associated with the PDCCH monitoring occasion corresponds to the priority associated with the LP-WUS monitoring occasion based at least in part on the LP-WUS monitoring occasion being associated with the PDCCH monitoring occasion.

13. The UE of claim 12, wherein the LP-WUS monitoring occasion comprises a first LP-WUS monitoring occasion, and wherein the one or more processors are further configured to cause the UE to:
receive an LP-WUS during a second LP-WUS monitoring occasion, and
wherein the second LP-WUS monitoring occasion is associated with a physical downlink control channel (PDCCH) monitoring occasion that at least partially overlaps with the MUSIM gap; and
monitor for the PDCCH during the PDCCH monitoring occasion based at least in part on a priority associated with the second LP-WUS monitoring occasion being a higher priority relative to the priority associated with the MUSIM gap, wherein the monitoring for the communication associated with the second SIM of the UE during the MUSIM gap is skipped based at least in part on the priority associated with the second LP-WUS monitoring occasion being the higher priority relative to the priority associated with the MUSIM gap.

14. The UE of claim 1, wherein the LP-WUS monitoring occasion comprises a first LP-WUS monitoring occasion, and wherein the one or more processors are further configured to cause the UE to:
receive an LP-WUS during a second LP-WUS monitoring occasion, wherein the second LP-WUS monitoring occasion does not overlap with the MUSIM gap, wherein a priority associated with the second LP-WUS monitoring occasion is a lower priority relative to the priority associated with the MUSIM gap, and wherein the second LP-WUS monitoring occasion is associated with a physical downlink control channel (PDCCH) monitoring occasion that at least partially overlaps with the MUSIM gap; and
monitor for the PDCCH during the PDCCH monitoring occasion based at least in part on receiving the LP-WUS during the second LP-WUS monitoring occasion, wherein the MUSIM gap is skipped based at least in part on receiving the LP-WUS during the second LP-WUS monitoring occasion.

15. The UE of claim 1, wherein the one or more processors, to cause the UE to skip, in connection with the LP-WUS monitoring occasion at least partially overlapping with the MUSIM gap, the LP-WUS monitoring during the LP-WUS monitoring occasion or the monitoring for the communication associated with the second SIM of the UE during the MUSIM gap, are configured to cause the UE to:
skip the LP-WUS monitoring during the LP-WUS monitoring occasion based at least in part on the priority associated with the LP-WUS monitoring occasion being a lower priority relative to the priority associated with the MUSIM gap.

16. A network node for wireless communication, comprising:
one or more memories; and
one or more processors, coupled to the one or more memories, configured to cause the network node to:
transmit configuration information associated with a first subscriber identity module (SIM) of a user equipment (UE), wherein the configuration information is associated with configuring at least one of a set of low power wake-up signal (LP-WUS) monitoring occasions or a set of multiple user SIM (MUSIM) gaps at the UE; and
selectively transmit, in connection with an LP-WUS monitoring occasion, of the set of LP-WUS monitoring occasions, at least partially overlapping with a MUSIM gap, of the set of MUSIM gaps, an LP-WUS during the LP-WUS monitoring occasion based at least in part on a priority associated with the LP-WUS monitoring occasion and a priority associated with the MUSIM gap, wherein the LP-WUS is transmitted based at least in part on the priority associated with the LP-WUS monitoring occasion comprising a higher priority relative to the priority associated with the MUSIM gap.

17. A method of wireless communication performed by a user equipment (UE), comprising:
receiving configuration information associated with a first subscriber identity module (SIM) of the UE, wherein the configuration information is associated with configuring at least one of a set of low power wake-up signal (LP-WUS) monitoring occasions or a set of multiple user SIM (MUSIM) gaps at the UE; and
skipping, in connection with an LP-WUS monitoring occasion, of the set of LP-WUS monitoring occasions, at least partially overlapping with a MUSIM gap, of the set of MUSIM gaps, LP-WUS monitoring during the LP-WUS monitoring occasion or monitoring for a communication associated with a second SIM of the UE during the MUSIM gap based at least in part on a priority associated with the LP-WUS monitoring occasion and a priority associated with the MUSIM gap.

18. The method of claim 17, further comprising:
receiving information indicating the priority associated with the LP-WUS monitoring occasion relative to the priority associated with the MUSIM gap.

19. The method of claim 18, wherein the information indicates that the priority associated with the LP-WUS monitoring occasion is a higher priority relative to the priority associated with the MUSIM gap.

20. The method of claim 19, wherein skipping, in connection with the LP-WUS monitoring occasion at least partially overlapping with the MUSIM gap, the LP-WUS monitoring during the LP-WUS monitoring occasion or the MUSIM gap comprises:
skipping the monitoring for the communication associated with the second SIM of the UE during the MUSIM gap based at least in part on the priority associated with the LP-WUS monitoring occasion being a higher priority relative to the priority associated with the MUSIM gap.
